(19) United States
(12) Patent Application Publication
(10) Pub. No.: US 2016/0210569 A1
(43) Pub. Date: Jul. 21, 2016

(54) SYSTEMS AND METHODS FOR BUILDING PERFORMANCE IMPROVEMENT

(71) Applicant: Harry Jay Enck, Buford, GA (US)

(72) Inventor: Harry Jay Enck, Buford, GA (US)

(21) Appl. No.: 14/599,756

(22) Filed: Jan. 19, 2015

(51) Int. Cl. G06Q 10/06

(52) U.S. Cl. CPC G06Q 10/0637

(57) ABSTRACT

Systems and associated methods are disclosed for conducting commissioning processes, including, by way of example, building commissioning, operational efficiency, building forensics, sustainable design and operations consulting, retro-commissioning, ongoing monitoring-based commissioning, building forensic investigations, energy audits, environmental design, and high performing buildings. Additionally, systems and associated methods are provided for such commissioning and the application of sustainable development principles. Furthermore, a computer readable storage medium encoded with programming for implementing methods for such commissioning is provided.

### FIELD OF THE INVENTION

The technology described herein relates generally to the fields of building commissioning, operational efficiency, building forensics, sustainable design and operations consulting, retro-commissioning, ongoing monitoring-based commissioning, building forensic investigations, energy audits, environmental design, high performing buildings, and benchmarking building performance. More specifically, this technology relates to systems and associated methods for conducting such commissioning processes. Furthermore, this technology relates to systems and associated methods for commissioning and the application of sustainable development principles.

### BACKGROUND OF THE INVENTION

Commercial buildings in the USA account for 46.3% of the total USA energy consumption and 17% of greenhouse gas emissions. In addition, 70% of the existing buildings in the USA do not perform as expected from an occupant satisfaction and operational efficiency perspective. Most building operations departments are in firefighting chasing complaints and making modifications to eliminate the complaint which typically have a negative impact by increasing the total cost of ownership. Most of these problems can be eliminated if the owner were to have a continuous feedback loop providing salient actionable information.

### BRIEF SUMMARY OF THE INVENTION

In various exemplary embodiments, the technology described herein provides systems and associated methods for conducting commissioning processes, including, by way of example, building commissioning, operational efficiency, building forensics, sustainable design and operations consulting, retro-commissioning, ongoing monitoring-based commissioning, building forensic investigations, energy audits, environmental design, high performing buildings, and benchmarking building performance. Additionally, this technology provides systems and associated methods for such commissioning and the application of sustainable development principles.

In one exemplary embodiment, the technology described herein provides a method for conducting building commissioning processes and building performance improvement. The method includes: providing a plurality of system agents, each agent configured to collect data from a plurality of sources and transmit the data, in an encrypted format, to a service provider; providing at least one system service, the system service residing on one or more servers at a service provider, the system service configured to receive the data from the plurality of system agents and to classify the data by client, building, and type of information received, and then to be stored in a system storage database; providing a plurality of system service analytics, each configured to review data and attributes for building commissioning and building performance improvement; providing a system storage database, the system storage database configured to store data collected by the plurality of system agents and processed by the at least one system service; collecting data from the plurality of sources, by the plurality of system agents; transmitting, by the plurality of system agents, the collected data to the service provider; receiving, by the at least one system service, the data transmitted from the plurality of system agents; classifying, by the at least one system service, the data by client, building, and type of information received; storing the received data in the system storage database; and identifying, by the system service and a plurality of system service analytics, operational issues affecting building performance.

In at least one embodiment, the method for conducting building commissioning processes and building performance improvement also includes prioritizing, by the system service and a plurality of system service analytics, the operational issues affecting building performance to achieve building performance improvement, lessened environmental impact, and increased efficiency of building operations and reduced expenses and total cost of ownership.

In at least one embodiment, the method for conducting building commissioning processes and building performance improvement further includes providing access to a building automation system (BAS). In this embodiment, each of the plurality of system agents is configured to the read building automation system (BAS) data and to store the data read. In additional embodiments, the plurality of system agents is configured to collect utility data, population profiles data (university class schedules, hospital room occupancies, airport arrival and departure information, etc.), accounting information (time sheets, utility cost, maintenance costs, etc.)

In at least one embodiment, the method for conducting building commissioning processes and building performance improvement still further includes providing a dashboard interface to provide a user with visual illustrations of the health and status of one or more client buildings using visual signals and indicia to indicate the wellness of the building and further to identify any problems of building health with the one or more client buildings.

In at least one embodiment of the method for conducting building commissioning processes and building performance improvement, each of the plurality of system agents is configured further to evaluate a building automation system (BAS) performance and to transfer data based on an availability of server resources so as to not impact performance of the BAS.

In at least one embodiment of the method for conducting building commissioning processes and building performance improvement, each of the plurality of system agents is configured further to clean up buffered data after successful transfer to the at least one system service and to log any issues with data retrieval, storage, and transfer.

In at least one embodiment, the method for conducting building commissioning processes and building performance improvement still further includes providing a user interface tool and configuring the plurality of system agents with the user interface tool.

In at least one embodiment, the method for conducting building commissioning processes and building performance improvement still further includes updating automatically, with software updates, the plurality of system agents. Each of the plurality of system agents is configured further to be automatically updated.

In at least one embodiment, the method for conducting building commissioning processes and building performance improvement still further includes storing, by the system storage database, building automation system (BAS) point meta data; and storing, by the system storage database, BAS point values.

In at least one embodiment, the method for conducting building commissioning processes and building performance improvement still further includes receiving, by the at least one system service, data using the HTTPS protocol; receiving, by the at least one system service, data using the SFTP protocol from a remote server; and processing and storing data, by the at least one system service, into the system storage.

In another exemplary embodiment, the technology described herein provides a system for conducting building commissioning processes and building performance improvement. The system includes: a plurality of system agents, each agent configured to collect data from a plurality of sources and transmit the data, in an encrypted format, to a service provider; at least one system service, the system service residing on one or more servers at a service provider, the system service configured to receive the data from the plurality of system agents and to classify the data by client, building, and type of information received, and then to be stored in a system storage database; a plurality of system service analytics, each configured to review data and attributes for building commissioning and building performance improvement; and a system storage database, the system storage database configured to store data collected by the plurality of system agents and processed by the at least one system service. The system collectively is configured to identify, by the system service and a plurality of system service analytics, operational issues affecting building performance.

In at least one embodiment of the system, the system service and a plurality of system service analytics is further configured to prioritize the operational issues affecting building performance to achieve building performance improvement, lessened environmental impact, and increased efficiency of building operations and reduced expenses and total cost of ownership.

In at least one embodiment, the system further includes access to a building automation system (BAS), wherein each of the plurality of system agents is configured to the read building automation system (BAS) data and to store the data read.

In at least one embodiment, the system further includes a dashboard interface to provide a user with visual illustrations of the health and status of one or more client buildings using visual signals and indicia to indicate the wellness of the building and further to identify any problems of building health with the one or more client buildings

In at least one embodiment, the system further includes a user interface tool. The plurality of system agents are configurable with the user interface tool.

In yet another exemplary embodiment, the technology described herein provides a computer readable storage medium encoded with programming for implementing a system for conducting building commissioning processes and building performance improvement. The computer readable storage medium encoded with programming is configured to: provide a plurality of system agents, each agent configured to collect data from a plurality of sources and transmit the data, in an encrypted format, to a service provider; provide at least one system service, the system service residing on one or more servers at a service provider, the system service configured to receive the data from the plurality of system agents and to classify the data by client, building, and type of information received, and then to be stored in a system storage database; provide a plurality of system service analytics, each configured to review data and attributes for building commissioning and building performance improvement; provide a system storage database, the system storage database configured to store data collected by the plurality of system agents and processed by the at least one system service; collect data from the plurality of sources, by the plurality of system agents; transmit, by the plurality of system agents, the collected data to the service provider; receive, by the at least one system service, the data transmitted from the plurality of system agents; classify, by the at least one system service, the data by client, building, and type of information received; store the received data in the system storage database; and identify, by the system service and a plurality of system service analytics, operational issues affecting building performance.

In at least one embodiment, the computer readable storage medium encoded with programming for implementing a system for conducting building commissioning processes and building performance improvement further includes wherein the programming is further configured to prioritize, by the system service and a plurality of system service analytics, the operational issues affecting building performance to achieve building performance improvement, lessened environmental impact, and increased efficiency of building operations and reduced expenses and total cost of ownership.

In at least one embodiment, the computer readable storage medium encoded with programming for implementing a system for conducting building commissioning processes and building performance improvement further includes wherein the programming is further configured to provide access to a building automation system (BAS). Each of the plurality of system agents is configured to the read building automation system (BAS) data and to store the data read.

In at least one embodiment, the computer readable storage medium encoded with programming for implementing a system for conducting building commissioning processes and building performance improvement further includes wherein the programming is further configured to provide a dashboard interface to provide a user with visual illustrations of the health and status of one or more client buildings using visual signals and indicia to indicate the wellness of the building and further to identify any problems of building health with the one or more client buildings.

In at least one embodiment, the computer readable storage medium encoded with programming for implementing a system for conducting building commissioning processes and building performance improvement further includes wherein the programming is further configured to update automatically, with software updates, the plurality of system agents; wherein each of the plurality of system agents is configured further to be automatically updated; store, by the system storage database, building automation system (BAS) point meta data; store, by the system storage database, BAS point values; receive, by the at least one system service, data using the HTTPS protocol; receive, by the at least one system service, data using the SFTP protocol from a remote server; and process and store data, by the at least one system service, into the system storage.

Advantageously, the systems and associated methods described herein provide operational information needed by an organization to efficiently and effectively manage its resources. The systems and methods disclosed herein provide the actionable information needed by the CEO/CFO, Facility Management Team, and Facility Operators to make informed decisions to efficiently and effectively manage their human and financial resources to lower the total cost of ownership for the life of the building.

There has thus been outlined, rather broadly, the more important features of the technology in order that the detailed description thereof that follows may be better understood, and in order that the present contribution to the art may be better appreciated. There are additional features of the technology that will be described hereinafter and which will form the subject matter of the claims appended hereto. In this respect, before explaining at least one embodiment of the technology in detail, it is to be understood that the invention is not limited in its application to the details of construction and to the arrangements of the components set forth in the following description or illustrated in the drawings. The technology described herein is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the technology described herein.

Further objects and advantages of the technology described herein will be apparent from the following detailed description of a presently preferred embodiment which is illustrated schematically in the accompanying drawings.

### BRIEF DESCRIPTION OF THE DRAWINGS

The technology described herein is illustrated with reference to the various drawings, in which like reference numbers denote like device components and/or method steps, respectively, and in which:

FIG. 1 is a schematic diagram illustrating a simplified graphical representation of an HVAC system, illustrating, in particular, the Zone which can be one room or multiple rooms within a floor or multiple floors of the building, according to an embodiment of the technology described herein;

FIG. 2 is a schematic diagram illustrating multiple zones served by individual air handling units per zone, according to an embodiment of the technology described herein;

FIG. 3 is a schematic diagram illustrating a typical floor plan for a variable air volume air handler, noting that there are two air handling units, and illustrating, in particular, that the system defines the zone and sub zones based on the HVAC design and graphically indicated these zones and subzones on the floor plan comprised of multiple polygons with color fill for easy recognition by the viewer as illustrated in FIG. 4, according to an embodiment of the technology described herein;

FIG. 4 is a schematic diagram illustrating the two main air handling unit (AHU) zones as identified by the different zone colors, and wherein the subzones are illustrated as the polygons of the same shade and the terminal unit (TU) serving the subzone is indicated within the polygon, and also illustrating the mapping of components and terminal units (TU) to the polygons, according to an embodiment of the technology described herein;

FIG. 5 is a schematic diagram illustrating, in particular, the HVAC zone and subzone, the components associated with the zone as represented in the subset component tables, see HVAC characteristics, and the selected points to be displayed with the component for both analysis and communication of operational issues associated with the subsystem, and illustrating how a subsystem and its components will be illustrated for both analysis and communication of operational issue to the client, according to an embodiment of the technology described herein;

FIG. 6 is a schematic diagram illustrating, in particular, the same basic configuration of zones and subzones as illustrated in FIG. 4, except that only the space temperature is displayed and a color represents if the zone is heating, cooling, or neither heating or cooling, and also illustrating a configuration of a level two analysis wherein using time interval data, the system methodically steps through the time records of outdoor temperature, and interior temperature of each subzone, and provides color infill to illustrate if the subzone is in heating (red), cooling (blue), or neither (white), and wherein the shading of spaces (doted pattern) is used to illustrate different equipment configurations, according to an embodiment of the technology described herein;

FIG. 7 is a schematic diagram illustrating, in particular, that the air handler serves a zone and the terminal boxes serve the subzones in the zone, according to an embodiment of the technology described herein;

FIG. 8 is a schematic diagram illustrating, in particular, results from mapping the subsystem tree components and points to the graphic, and illustrating how subsystems types such as air handling units (ahu) relate to other systems such as chilled water loop (chwl), and illustrating a typical chilled water loop that provides chilled water to all of the air handlers in the building, according to an embodiment of the technology described herein;

FIG. 9 is a schematic diagram illustrating, in particular, where an outside air unit (DOAS) provides outside air to all of the air handling units in the building, according to an embodiment of the technology described herein;

FIG. 10 is a schematic diagram illustrating, in particular, retrieval of data over predetermined time intervals, according to an embodiment of the technology described herein;

FIG. 11 is a schematic diagram illustrating, in particular, retrieval of data over predetermined time intervals, according to an embodiment of the technology described herein;

FIG. 12 is a schematic diagram illustrating, in particular, retrieval of data over predetermined time intervals, according to an embodiment of the technology described herein;

FIG. 13 is a schematic diagram illustrating, in particular, Step 1 of the processing wizard to ultimately populate the BAS Point Classification Table, according to an embodiment of the technology described herein;

FIG. 14 is a schematic diagram illustrating, in particular, Step 2 of the processing wizard to ultimately populate the BAS Point Classification Table, according to an embodiment of the technology described herein;

FIG. 15 is a schematic diagram illustrating, in particular, Step 3 of the processing wizard to ultimately populate the BAS Point Classification Table, according to an embodiment of the technology described herein;

FIG. 16 is a schematic diagram illustrating, in particular, Step 4 of the processing wizard to ultimately populate the BAS Point Classification Table, according to an embodiment of the technology described herein;

FIG. 17 is a schematic diagram illustrating, in particular, Step 5 of the processing wizard to ultimately populate the BAS Point Classification Table, according to an embodiment of the technology described herein;

FIG. 18 is a schematic diagram illustrating, in particular, Sample Trends data as viewed through a client's Building Automation System and viewed through a web portal webpage for display, as a client dashboard, according to an embodiment of the technology described herein;

FIG. 19 is a schematic diagram illustrating, in particular, a Campus Map view with the client dashboard, wherein the building location is used to map the building location on a geographical map of the campus, according to an embodiment of the technology described herein;

FIG. 20 is a schematic diagram illustrating, in particular, a Campus Table, which is a reference for the utility data contained in one of the following: BAS point name, excel file, SQL database, or a paper copy of a utility bill, according to an embodiment of the technology described herein;

FIG. 21 is a block diagram illustrating the general components of a computer, according to an exemplary embodiment of the technology;

FIG. 22 is a block diagram illustrating the general components of the building performance improvement system, according to an exemplary embodiment of the technology;

FIG. 23 is a flowchart diagram illustrating method steps for a System Agent, according to an exemplary embodiment of the technology;

FIG. 24 is a flowchart diagram illustrating method steps for the System Storage, according to an exemplary embodiment of the technology;

FIG. 25 is a flowchart diagram illustrating method steps for the System Service, according to an exemplary embodiment of the technology; and

FIG. 26 is a flowchart diagram illustrating method steps for the System Dashboard, according to an exemplary embodiment of the technology;

### DETAILED DESCRIPTION OF THE INVENTION

Before describing the disclosed embodiments of this technology in detail, it is to be understood that the technology is not limited in its application to the details of the particular arrangement shown here since the technology described is capable of other embodiments. Also, the terminology used herein is for the purpose of description and not of limitation.

In various exemplary embodiments, the technology described herein provides systems and associated methods for conducting commissioning processes, including, by way of example, building commissioning, operational efficiency, building forensics, sustainable design and operations consulting, retro-commissioning, ongoing monitoring-based commissioning, building forensic investigations, energy audits, environmental design, high performing buildings, and benchmarking building performance. Additionally, this technology provides systems and associated methods for such commissioning and the application of sustainable development principles.

The systems and associated methods disclosed herein can evaluate a single building, a campus of buildings, or a portfolio of buildings located in a variety of geographical locations, utilizing data that the software collects from numerous sources. The system disclosed herein is unique in that it processes data into meaningful and actionable information so that the building owner's operational team can use it to lower the total cost of ownership for the building or portfolio of buildings.

Based on the data and analysis performed, the application monitors the building operation and automatically communicates operational changes to the Building Automation Systems (BAS) for execution. By doing so each building's utility peak demand and associated costs are lowered, occupant satisfaction and productivity are improved, and building operational efficiency is increased lowering the total cost of ownership. The system helps to bridge the gap in communication between the between the owners' technical and management staff by providing specifically tailored information that meets the need of each person, allowing them to make informed decisions about how to best allocate human and financial resources.

System Overview

The building performance improvement system is comprised of multiple modules that perform specific functions in order to provide a constant feedback loop to the Owner's staff and instructions to the BAS including: 1) System Agents; 2) System Service; and System Analytics. System Agents collect data from various sources and transmits this data in an encrypted format to System Servers. System Service, which resides in System Servers, receive the data and classifies the data by Client, Building, and Type of information received, which is then stored in the System Storage database. System Analytics systematically retrieves the data for evaluation and provides various data points and results. By way of example, System Analytics provides 1) Measurement and verification baseline calculations by which to calculate cost avoidance, related to modifications to the facility; 2) Detailed information used by CEOs, CFOs, Facility Managers, Resources Managers, and Technicians; and 3) Identification of operational issues (OIs) affecting building performance with prioritized actions to achieve significant improvement to the triple bottom line such as occupant satisfaction, lower total cost of ownership, and environmental impact to our planet. The system prioritizes OIs and optimization opportunities based on the impact and associated cost avoidance when corrected by evaluating, by way of example: 1) Identified operational issues impacting occupant productivity, operational costs, and greenhouse emissions; 2) Impact of unexpected component/equipment failure; and 3) Data from the Smart Grid.

System Reporting

A critical element of analysis is the ability to distill large volumes of data down to succinct bits of needed information by the various levels of an organization. The information needed by a CEO or CFO are significantly different from the information required by the Facility Manager, Utility Resource Manager, and Technicians. This is also true for each of the facility operational positions. The system disclosed herein provides a continuous feedback loop to all levels within the organization to allow tracking of performance from a people, planet, and financial perspective. The system provides financial information associated with: 1) Utility usage and human resource efficiency; 2) Conformation of operational issue correction; 3) Duration of time and magnitude of cost associated with each issue identified; 4) Comparison of optimal performance against actual; and 5) Overall health of each building, and effectiveness of operational optimization.

The following paragraphs summarize the specific type of information needed from a continuous feedback loop of information by the different levels of the building Owner's organization. Levels includes: 1) CEO and CFO; 2) Facility Managers (FM); 3) Resource Managers (RM); and 4) Technician or Contractor (Tech).

The CEO and CFO need financial data relative to estimated cost avoidance of recommendations, impact to occupant efficiency and productivity, capital costs of modifications; Rate of Return, Return on Investment, and a high level of information about the suggested modifications to make informed financial decisions. Examples include calculation of the overall health of the building in comparison to its potential peak performance including a summary of overall building health statistics on Occupant Satisfaction to evaluate productivity of occupants and Operational staff performance in completing Operational Issues (OI) repair tasks and including estimated cost benefit analysis for the top 10 System prioritized OIs needing correction with associated returns. Examples also include calculation of labor savings based on Centralized Maintenance Management System (CMMS) data, resulting from the System. Examples also include calculation of aggregated savings on a monthly, year to date, and period from implementing the System. Examples further include a Site map, displayed on the system dashboard, illustrating the health of the client's building or buildings using color coded signals to indicate excellent, good, fair, and poor health of the building. This allows for quick recognition of the building's overall status and identifies the greatest problems.

Facility Managers (FM) need information that is a blend of the type of information needed by the CEO/CFO and resource managers. The FM receive the same reports provided to the CEO/CFO. More detailed information can include the following, for example: 1) Indication of general locations within the buildings, where occupant dissatisfaction is identified and the type of complaint; 2) Buildings where similar repair tasks take longer than other buildings based on average hours for the specific task that are statistically above the standard mean and typical deviation for the repair task preformed; 3) Estimated cost benefit analysis for the top 50 system prioritized OIs needing correction with associated returns; 4) List of top 50 OIs by age of OI (how long has the OI been reported to building operations); 5) Summary of infrastructure condition remaining life, replacement costs, impact of pending equipment failures; 6) Statistical utilization of space within the building; 7) Estimated repair costs by Operational issue from operational staff (typically items outside of Facility Operations annual budget) or actual repair costs from the CMMS; and 8) Site map, displayed on the system dashboard, illustrating the health of the client's building or buildings using color to indicate excellent, good, fair, and poor health to allow quick recognition of buildings, with the greatest problems.

Resource Managers (RM) need information that is a blend of the type of information needed by the CEO/CFO, FM, and Technicians. The RM receives portions of the same reports provided to the CEO/CFO and FM. More detailed information can include the following, for example: 1) Site map, displayed on the System dashboard, illustrating the health of the client's building or buildings using color to indicate excellent, good, fair, and poor health to allow for quick recognition of buildings with the greatest problems, including calculation of the overall health of the building in comparison to its potential peak performance to provide the owner and their operational team with the ability to quickly recognize the building problems in their portfolio or campus; 2) Calculation of the overall health of the building in comparison to its potential peak performance, including summary of overall building health statistics on Occupant Satisfaction to evaluate productivity of occupants, Energy and water efficiency, Greenhouse gas emissions, and Operational staff performance in completing OI repair tasks; 3) Calculation of labor savings based on CMMS data, resulting from the System; 4) Calculation of aggregated savings on a monthly, year to date, and period from implementing the System; 5) Indication of general locations within buildings of occupant dissatisfaction and the type of complaint and associated OI in general area of the building; 6) Buildings where similar repair tasks take longer on average and statistics by repair task preformed; 7) Estimated cost benefit analysis for all OIs needing correction identified by the System; 8) Prioritization based on building health score, cost benefit analysis, calculated cost avoidance magnitude, and severity of issue; 9) Calculation of compounded operational issue costs categorized by equipment, system, and building; 10) Categorization OI by equipment and equipment component types to facilitate assignment of human resources with the right set of skills to correct the OIs; 11) List of OIs by age of OI (how long has the OI been reported to building operations); 12) List of OIs in process of being corrected; 13) Detailed OI reports that illustrates the operational issues, its location, suggested tasks/actions needed to resolve the problem, and confirmation that the repair/modification corrected the operational issue, and including the following summarizes the types of information contained in the OI reports: Identification of building system component malfunction (Fault Detection), degradation of component performance, or pending component/assembly failure facilitating reliability centered maintenance and just in time repairs; Identification of building system conflicts, including: Scheduling of building systems to operate when unnecessary including but not limited to interior and exterior lighting, HVAC system operation, elevator operation, process equipment, etc.; Control system conflicts within building systems including but not limited to daylighting and electrical lighting controls, elevator call response, cycling of elevator movement, HVAC system operation, electro-chromatic glazing operating or other active devices or building systems, pumping stations, compressed air systems, etc.; and Incorrect heating, ventilation, air conditioning, and refrigeration operation due to initial design and construction or operator modification; and 14) Detailed building optimization reports including: Identification of opportunities to optimize system performance based on building usage, building characteristics (form and orientation, thermal capacitance, overall heat transfer coefficients, glazing characteristics, etc.), population profiles (number of occupants at any given time and their location in the building), and geographical location; Based on building's characteristics and operation data from changes in weather, occupancy profiles, HVAC operation the System identifies how to optimally operate the building to achieve the lowest energy consumption, minimize and control demand rates from utility resources relative to time of day costs, while maintaining occupant satisfaction. The System first identifies which set points and equipment operational schedules should be modified based on actual operating conditions and communicates when to modify these parameters. Parameters that affect set points and equipment schedules are based on: Location of occupants in the building; the schedule of when occupants are present by location; how long the occupants will be present; the weather conditions; the building form and orientation; interior thermal lag times due to buildings thermal capacitance. The System's analysis of these parameters and reporting provides a written plan in the form of automatic reports that operational staff can review and agree to before directing the System to send these modifications to the Building Automation System (BAS) for implementation. Because the System analyzes data on an ongoing basis it incorporates modifications in occupant schedules, weather, and utility rates in the guidance given to operators as well as automatic modification to the BAS. The System's ability to analyze the actual operating conditions also allows it to provide predictive assessment of impact or proposed major building system and assembly modifications (HVAC, Lighting Building Envelope renovations/alterations).

A Technician or Contractor (Tech) needs information that is a blend of the type of information needed by the RM and the specific information required to correct the OI. The Tech receives portions of the same reports provided to the RM plus more detailed information including the indication of general locations within buildings of occupant dissatisfaction and the type of complaint and associated OI in general area of the building. Detailed OI reports that illustrate the operational issues, its location, suggested tasks/actions needed to resolve, and conformation that the repair/modification corrected the operational issue.

System Details

The system consists of several parts which are required to provide the information to the technician, building operational staff, facility managers, and the financial decision makers who evaluate the business case for investments made to meet their mission.

The system includes Agents to collect data from various sources.

The system includes a Service to manage data received from agents, scrubbing, grooming, filing, retrieval, analytics, visualization, and reporting of information. Data can include importing of electronic data from Building Information Models (BIM), Computer Aided Design files, occupant surveys, CMMS data files of databases, Construction Operations Building Information Exchange (COBie) files, electronic spreadsheets, graphic files (i.e., adobe, JPEG, TIFF, paint, etc.), data loggers, etc. Data can include translating inputs from non-electronic media such as paper copies of construction documents, test and balance reports, field reports, manual utility meter readings, etc. The Service can include data storage and retrieval. The Service can include analysis engines. The Service can include web-based dashboards for user interface through the internet, which includes: 1) client access, such as limited access to client selected data and full access to data and reports; 2) partner access such as full access to their client's data and reports and limited access to the System functions; and 3) system management access such as staff access and administrator access.

Agents

Agents collect data from various electronic data sources that are used by the Service in performing analytics to identify opportunities to reduce the total cost of ownership through improved building, staff, and occupant performance. The Agents retrieve data from the databases that contain information that impact a building's performance, including but not limited to, local weather, occupancy, hours of operation; operation of the heating, ventilation, air conditioning, and refrigeration systems (HVACR); building egress, lighting, elevator operations, utility metering and submetering, and other independent sensors (i.e., vibration, oil analysis, motor circuit analysis, etc.). Common databases accessed by the Agent are the building automation systems (BAS), central maintenance management systems (CMMS), Human Resource Department and accounting records, National Ocean Atmospheric Administration (NOAA) weather stations, Utility Provider records, lighting control systems, data logging systems with their wide variety of sensors measuring physical properties, etc.

The Agents collect data from one of the data sources described above. Residing on the database server or on a virtual server with intranet access, the Agent collects data from the targeted database and transfers the data to the Service via the internet. The Agent monitors and evaluates the server it resides on and its resources (processors, data storage, receive and transmit utilization) and computes when to send and how much data at any given time to the Service. The Agent's continuous evaluation of the resident servers resources are to prevent overloading the IT system while systematically and efficiently transferring data to the Service, thus preventing IT problems from occurring. Data transfer utilizes secure transfer procedures and safeties to prevent unauthorized access through the Agent. The Agent also contains a database cleanup and backup functions. The Agent can also reside on the Service server and retrieve data from the utility provider and NOAA websites, flash drives or other types of portable storage devices. The Data Retrieval Algorithm defined below is used to evaluate server resources utilization.

The Data Retrieval Algorithm

The Data Retrieval Algorithm is used to obtain data from a database and avoid overloading the Information Technology infrastructure. The main factors are: 1) Limiting the throughput between the System Agent and database to limit the resource usage; and 2) Spreading out the task in time to optimize the resource usage. The algorithm also limits the amount of data that is received from the database per single point. This allows data to be retrieved from points that write excessively without clogging up the memory or hard-drive space of the server where System Agent is installed.

The Data Retrieval Schedule

Point-day can be defined as the maximum amount of values that are retrieved for a single point over a one day period. The calculation of this amount is defined in the section Data Retrieval Algorithm. The following are configurable variables: 1) Sₘₐₓ—Maximum allowed throughput from database to the System agent, measured in point-days/second. Using this variable the algorithm limits the server load; and 2) Pₘₐₓ—Maximum points that we retrieve per single run. Using this variable the algorithm calculates the interval at which to run to obtain all the data from the database; and 3) K—Delay retrieval period in hours. This is the delay needed for data from the application writing to the selected database to write whole data from the previous day. While this algorithm can be applied to any database, large databases (gigabyte and terabyte volumes of data) such as, the building automation system database is the primary use of the algorithm.

The general data retrieval schedule for a building automation system (BAS) database is as follows: 1) Once per 24 hours Data Retrieval master task is run, which defines the following variables: a) P=amount of points in the BAS SQL database; and b) D=amount of days that need to be obtained from BAS SQL database from minimal initial date to current dat−K hours; and 2) Once defined we perform the algorithm for calculating the interval at which to run: T=24*60*60; 1 day in seconds. Period in which we prefer to process all points for all days.

$$S = \frac{P * D}{T}$$

Throughput we need to process all points for all days in next 24 hours.

if (S>Sₘₐₓ){
If the throughput is larger then allowed by configuration, then

S=Sₘₐₓ
Define the throughput to maximum allowed.

$$T = \frac{P * D}{S}$$

And, calculate the amount of time it will take to process all points for all days. This means that the next run will be in T (>24 hours). This is logged. If there are a lot of historical data, this is normal. But this could also mean that throughput is too small and the data for 1 day for all points can't be retrieved in 24 hours, which could cause data build-up in BAS SQL database.

$$\} {R}_{1} = ⌈ \frac{P}{{P}_{max}} ⌉$$

Amount of runs needed to retrieve data for all points for 1 day.

$${A}_{1} = ⌈ \frac{P}{{R}_{1}} ⌉$$

Data for maximum of A₁ points need to be retrieved per 1 run.

R_{T}=R₁*D
Total amount of point-days that need to be retrieved.

$$I = ⌊ \frac{T}{{R}_{T}} ⌋$$

Interval in seconds at which we need to run and retrieve data for up to A₁ points.

The Data Retrieval Algorithm

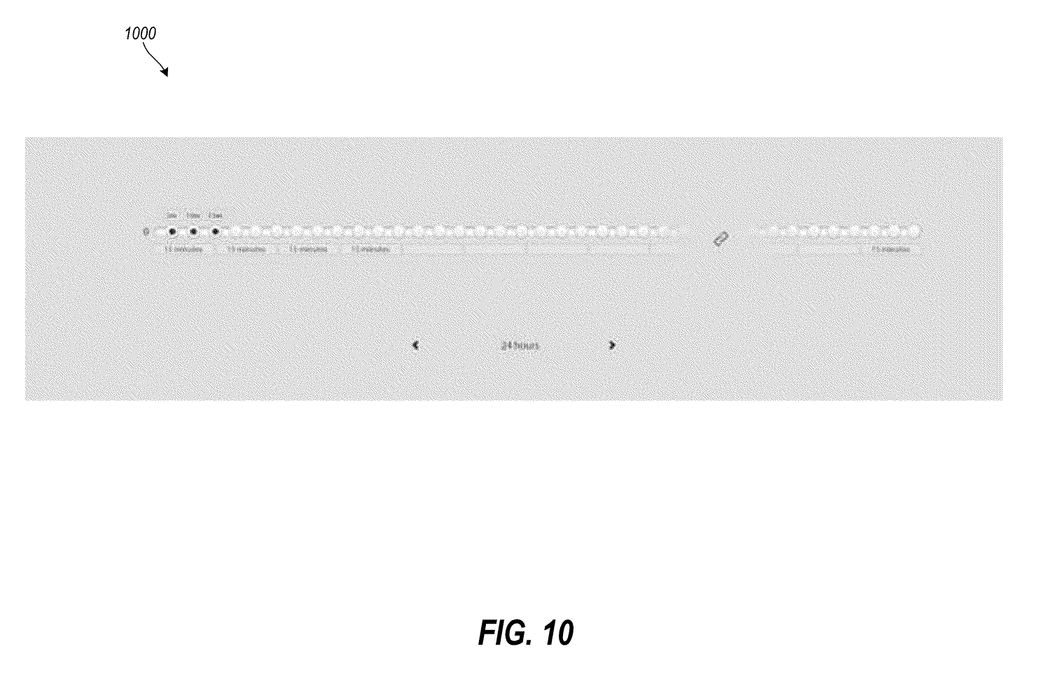

The above section describes how often the data retrieval task will run. The below section concentrates on what data the task will retrieve. The following are configurable variables: 1) S—Interval in minutes by which the 24 hour data is split. The default value is 15 minutes; and 2) N—Amount of values that are retrieved per interval S. The default value is 3. The algorithm will divide the 24 hour period in S minute intervals and obtain the first N values for each interval. This algorithm works optimally with Format 1 and Format 2 data as well as excessive data for a point. With excessive data, the algorithm obtains a spread out subset of values, which allows getting a picture of the whole 24 hours period. Using the default values we will receive a maximum of 288 (3*4*24) values. This can be seen in FIG. 10 diagram 1000. If there will be more than N values—only the first N will be retrieved:

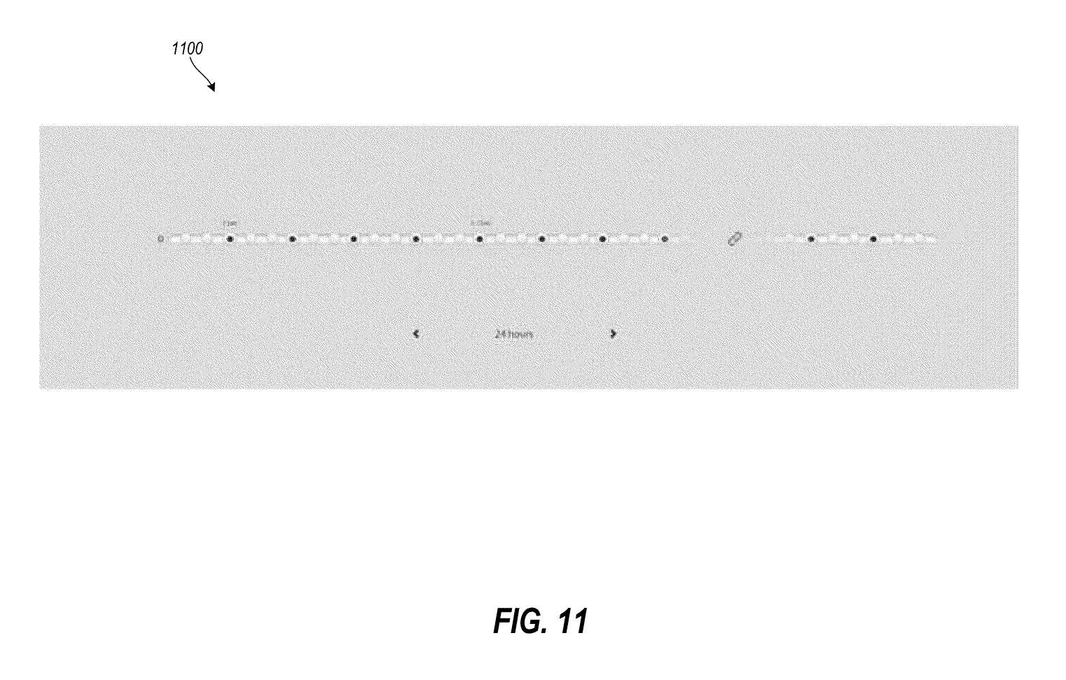

In FIG. 11 the diagram 1100 shows the retrieval of 15 minute data (Format 1), which is 1 value from each record per 15 minute interval:

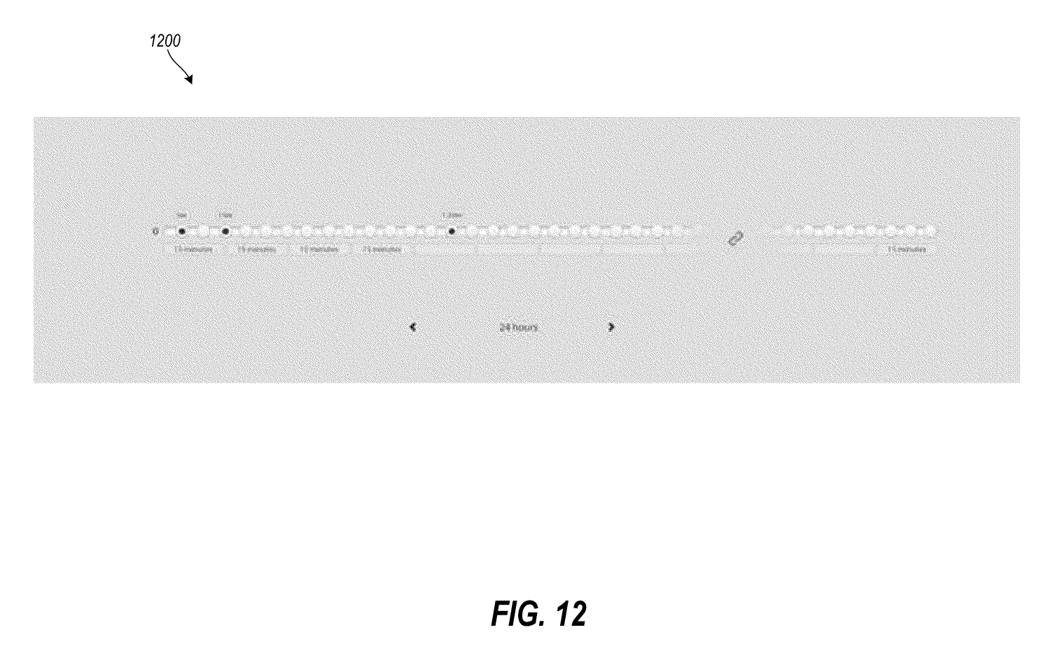

The COV values will fit into one of the 15 minute intervals, as shown in FIG. 12, diagram 1200.

Service

Building Energy Related Baselines and Calculation of Improvement

Energy related factors affecting the building's performance include but are not limited to solar heat gain, wind, outdoor temperature, dew point, relative humidity, population profile (number and location of people within a given building), hours of operation, plug loads, internal and exterior lighting to the building, process loads (cafeteria, coffee shop, printing service, etc.), and efficiencies and operation of HVACR system.

Weather data (solar, wind; outdoor temperature, dew point and relative humidity) are obtained from NOAA weather stations, building automation outdoor sensors, and private weather stations.

Population profiles are obtained from human resources records, college registrar's office records, building sensors connected to a BAS system or independent data logger.

Hours of operation, indoor air temperature, operation of the HVACR systems, and Utility submetering (lighting, plug, process loads) data collected by the BAS are obtained from the BAS database or similar controls system or data logging system databases.

To effectively evaluate changes in performance, the Service calculates a measurement and verification baseline utilizing both industry recognized procedures and not currently recognized procedures. The main current industry recognized procedure used by the Service is a hybrid inverse model combined with periodic short term measurements from main electrical distribution panels, utility meters and submeters that provide daily data granulated into timed intervals, typically 15 minute intervals (can be set to any time interval). The hybrid model correlates building automation system data (HVAC component operation information), lighting control system data, weather data, and other available data sets with granulated meter data of consumption and demand in to a multiple point linear regression model. The accuracy of the model is verified over a two month period and adjusted as needed to obtain accurate prediction of utility consumption prior to making modifications to the building. As operational issues are identified through the Service's analytics functions and the recommended system modifications are completed, energy reductions and cost avoidance are calculated by comparing the baseline model to actual consumption and demand recorded by the meters. The baseline utilizes a hybrid inverse model (HIM) using Daily (D) energy use compiled over a short term of a two month period. The HIM-D model utilizes monthly meter data from building meters and submeters including short term metering of the main electrical panel, lighting, plug, process, and special use loads (food prep, printing service, etc.) as well as HVACR operational data from the building automation system (chilled and hot water usage, HVACR fan, pump, compressor, outdoor air dampers, etc. operation) to obtain correlation with HVAC, internal loads, occupancy profiles, and weather variations for the purpose of predicting the buildings performance for a full year. This process is examined periodicity when significant changes to the building occur such as additions, changes to building enclosure, lighting retrofits, and other energy conservation measures are implemented.

The not yet recognized hybrid model has the ability to consider solar radiation gains on each exterior surface of the building, as well as impacts of population profiles within the building; but also the buildings mass, its contribution to the associated resistance changes in indoor temperatures. All of which have an effect upon the HVAC systems' energy consumption, providing a more accurate prediction of energy consumption and demand establishing a baseline prior to modification of the building and its associated systems to allow a more accurate prediction of energy usage by which to benchmark the improvements in the buildings performance. The System also uses the changes in building performance and compares the actual against the predictive model used to calculated estimated savings associated with OI. The operational issues are calculated using engineering calculations (i.e., fan speed, ΔT, indoor and outdoor sensible temperatures, dew point, discharge temperature, etc.) to estimate savings that are expected to occur as a result of correction of an operational issue. This hybrid model is partially useful for buildings with high amounts of glazing, effects of varying building forms and orientation, ground source heat pump systems, dedicated outdoor air systems (DOAS), and variable refrigerant flow systems (VRF) all of which are becoming more common in new buildings. These types of buildings and systems are less susceptible to outdoor conditions and therefore are less likely to be predictable with the traditional modeling methods.

Envelope-Solar Performance Parameters

Duct losses will be part of “envelope-solar” loads and performance; Performance parameters are expected to be modeled by HVAC zone. Envelope-solar loads are obtained from Equation E-1. The modeling process includes identification of exterior HVAC zones and interior HVAC zones. Exterior zones include exterior building enclosure surface areas. Interior zones do not have exterior building enclosure surface building areas except where the interior zone has a roof providing envelope-solar loads. Solar loads are from solar heat gain as a result of solar energy falling on the surface of the building exterior. The following calculations separate the HVAC loads for improved modeling of the buildings utility consumption.

qₑₙᵥ₋ₛₒₗₐᵣ=q_{HVAC}−qᵢₙₜₑᵣₙₐₗ−qᵥₑₙₜ Modifying Eqn E-1

Where now the quantity on the left side includes both envelope and solar loads. q_{HVAC}, qᵢₙₜₑᵣₙₐₗ, and qᵥₑₙₜ are all determined from known quantities.
On an hourly basis, by HVAC zone:
q_{HVAC}=CFMₜₒₜₐₗ×4.5×change-in-enthalpy, Btu/hr
qᵢₙₜₑᵣₙₐₗ=sum of internal loads, with kWh converted to Btu/hr, kWh×3412=Btu/hr
qᵥₑₙₜ=CFMₒₐ×4.5×change-in-enthalpy, Btu/hr, allocation of outdoor air unit CFM by floor, or calculation of outdoor air CFM based on sensing of percent outdoor air
4.5=60 min/hr×0.075 lb/ft³, if different densities should be calculated, this factor can be calculated directly as 60 times the density in lb/ft³
Hourly value of qₑₙᵥ₋ₛₒₗₐᵣ for each zone is determined from Eqn E-1, using the interior and exterior HVAC zones by-floor, hourly values of the quantities above.

Envelope-solar performance parameters are determined by modeling qₑₙᵥ₋ₛₒₗₐᵣ as a function of outdoor temperature and solar radiation. Multiple solar radiation values will be available. Most of the time, solar is correlated with outdoor temperature, and will not provide an independent driver signal in a model. When there is a solar driver that can be picked up, total horizontal (Btu/hr/ft2) usually works as the independent parameter. [kWh/m2×0.0929 ft2/m2×3,412 Btu/kWh=Btu/hr/ft2, although conversion is not necessary, except for simplicity of understanding model coefficients].

Indoor temperature should be used as a stratifying or binning parameter, meaning that indoor temperature would be a “qualifier” of the envelope-solar parameters, but not used in the model. An example statement of performance would be, “For an indoor temperature of 75° F., the envelope-solar performance parameters on this floor equal ‘x’ and ‘y’.”

Model Form

qₑₙᵥ₋ₛₒₗₐᵣ=function[outdoor temperature, solar], where the solar parameter is typically total horizontal solar radiation (insolation). Modeling is proposed to be by ordinary least squares regression, linear (data-driven). Missing values are not treated as zeroes. The System provides an algorithm based on data type and length of period associated with the missing records, information from adjacent spaces of similar characteristics, and other sources or local weather data to fill the missing data.

Modeling results are by week, i.e., one week of hourly data at a time, with model results reported each week. Weekdays and weekend/holidays are analyzed separately as well as together (where it says “weekend” following, it includes holidays also).

Results

Results are reported for the following: 1) Model coefficients for intercept and slope for weekdays, outdoor temperature only; 2) Model coefficients for intercept and slope for weekends, outdoor temperature only; 3) Model coefficients for intercept and slopes for weekdays, outdoor temperature and solar; 4) Model coefficients for intercept and slopes for weekends, outdoor temperature and solar; 5) Model coefficients for intercept and slope for all days, outdoor temperature only; 6) Model coefficients for intercept and slopes for all days, outdoor temperature and solar.

In addition to coefficients, overall model F-value, significance of the model and the coefficients, and R2 and adjusted R2 values are reported. In cases where the solar coefficients are not “significant,” those results are filtered out as the performance calculations.

The model coefficient for outdoor temperature has the units of Btu/hr-F. The model coefficient for solar depends on the form of the solar quantity, e.g., if envelope-solar load is regressed against total horizontal per square foot, the model coefficient would be Btu/hr per Btu/hr/ft2, or simply ft2, which is interpreted as some type of translated (or effective) aperture area.

The higher the temperature coefficient, the more sensitive HVAC loads on that floor are to outdoor temperature. The higher the solar coefficient, the greater the impact on HVAC loads of insolation (the “effective” solar load aperture area is higher).

Additional Intelligence

The System discerns HVAC system anomalies, such as where heating and cooling systems fight each other (i.e., incorrect minimum heating and cooling air volumes settings, resulting in overheating or cooling of zones and subzones, control hunting, simultaneous heating and cooling, etc.). Modifying results based solely on net change in enthalpy of supply air from inlet to outlet distribution.

Building Occupant and Operational Staff Performance Baselines Calculations

Occupant Satisfaction-Productivity Evaluation

Occupant satisfaction, which relates directly to employee productivity, is obtained through an electronic survey completed by the building occupants in schedule time periods, determined by the building owner or tenant. The occupant survey is distributed electronically by the owner's IT department prior to modifications and at least annual anniversaries to the full-time building occupants for the buildings using the System and their responses are recorded and stored on the System server. This information is provided in a written report generated by the System and is also available on the System dashboard. The initial result of the survey establishes the buildings baseline prior to modification of the building and its associated systems. The survey questions are designed to record the occupant's physiological and psychological perception of their working environment, to identify problems impacting their ability to efficiently and effectively perform their mission. The survey does not identify people in the building, unless they wish to identify themselves, but it does record the part of the building of where they are located, to assist with identification of operational issues impacting their comfort/productivity. Results are provided along with identification of operational issues that could be contributing to the occupants' dissatisfaction. This component is to establish a baseline of occupant satisfaction and measure increases and decreases which factor into the building's health rating.

Operational Staff Productivity Evaluation

Efficiency of operational staff activities can be judged by length of task effort.

Evaluation and Identification and Correction of Operational Issues

The factors that affect task effort are length of time to recognize each of the following task categories including identification that an operational problem exists, correct diagnosis of the problem, obtaining the parts needed for repair, making repairs, adjustments to the equipment to resolve issue, length of time between repairs or adjustments, and the permanence or persistence of the modification in resolving the issue. The times associated with these tasks define the efficiency of operational staff activities. A large part of the cost avoidance is the ability to increase efficiency of staff activates as a factor of time expended by human resources. The number of trips to resolve an OI represents use of transportation resources, which factors into cost avoidance. For this analysis we assume that the technician has the tools and knowledge necessary to make the modification. The System integrates the owner's CMMS information to evaluate efficiency of operational staff activities. A System Agent is installed on the CMMS server or virtual server with access to CMMS database. The baseline for evaluation of improvements in operational staff efficiency as a result of the System are calculated during an initial three months period during which time the System collects and calculates a baseline by task type based on the parameters listed by the System. Statistics are automatically generated by the System providing mean and standard deviation of effort associates with the tasks assigned through the CMMS software and illustrate in the System dashboard.

Preventative Maintenance Evaluation

The factors that affect preventative maintenance effort are access, number of pieces of equipment, and repairs identified during the preventative maintenance activities. Using the similar time tracking categories time will be recorded by operational staff as they complete the preventative maintenance procedures based on the CMMS preventative maintenance procedures and checklists. This information will be correlated with the specific pieces of equipment being maintained. Repairs required will be recorded and frequency of repair tracked. The System collects and calculates a baseline by task type based on the parameters listed by the System. Statistics are automatically generated by the System providing mean and standard deviation of effort associates with the tasks assigned through the CMMS software and illustrated in the System dashboard.

BAS Data Management

The application stores data collected from various sources for use in analyses to provide information that assists owners and their operational staff with lowering the total cost of ownership and carbon emissions while improving operational performance and occupant wellbeing.

Classification of Building Automation System Data

Classification of Building Automation System (BAS) data and its relational associations required to perform the levels of analysis include:

The application provides semi-automatic classification of BAS points collected by the System BAS Agent. The semi-automatic classification function facilitates translation of BAS point information for population of BAS Point Name Classification Table. The BAS Point Classification Table contains each point's record that describes the point characteristics, hierarchy and relationship to other system components that constitute the buildings heating, ventilation, and air conditioning (HVAC) system; units of measure associated with the recorded values from the BAS system, building and area of building served. Each BAS point belongs to a specific component. Depending on the BAS controls contractor mapping of the points the point name can contain the information necessary to classify a BAS point. However, it is also very common that not all of the information needed to classify the point for analysis purposes is contained in the BAS point name.

The application provides a method of breaking the BAS point name into its parts so that the point can be classified. The translation of the BAS point into a point classification table utilizes a sample string of data from the BAS point name that is broken down into elements. Each element of the BAS point name string are assigned to a specific field in the UI that identifies what portion of the point name indicates BAS Server, BAS Controller, Network, Building System Type, Component Type1, BAS Identifier, Component1 Tag, Component1 Number, Component2 Type, Component2 Tag, Component2 Number, Component Point Type, Point Name, Unit, and Point Tag. BAS point names are cryptic in nature and typically are in short hand format implemented by the BAS controls contractor programmer. Due to the variability in BAS point name naming conventions, the BAS point names must be classified, as described above. To facilitate semi-automatic translation of BAS point names requires a second group of fields where System Management can fill in the missing information that allows a BAS point name to be correctly translated in the point classification process. Identical to the fields where the BAS point name string is broken into elements i.e., BAS Server, BAS Controller, Network, Building System Type, Component Type1, BAS Identifier, Component1 Tag, Component1 Number, Component2 Type, Component2 Tag, Component2 Number, Component Point Type, Point Name, Unit, and Point Tag. System Management assigns missing information necessary to assist with translation of BAS point information that is used to populate the Point Classification Table for the BAS points matching the BAS point name string. In doing so, the point information from the point is correctly categorized in the application database to facilitate the application's analysis functions. The BAS Point Classification Table contains the information that defines which BAS Server, BAS Controller, Network, Building, Building Area, Building System Type, Component Type1, BAS Identifier, Component1 Tag, Component1 Number, Component2 Type, Component2 Tag, Component2 Number, Component Point Type, Point Name, Unit, and Point Tag the BAS point is associated with. Since BAS point names often lack all required information to classify the name the application must either extract the missing data from a BAS database or allow assignment of information in the missing fields by System Management using reference to the Point and Point Unit Tables. The BAS Point Classification Table and Point Name and Point Unit Name tables provide consistency to the BAS point names. This allows correction associated with BAS controls contractors variations in BAS point naming conventions which can cause difficulty with clearly identifying which component, building, and building area is served by the multiple HVAC system components. This also allows many trend points from different types of equipment to be gathered and classified with minimum manual modification for common similar BAS naming such as utilities where limited data is gathered for boilers, water heaters, chillers, pumps, etc. and the BAS controls contractor labels the component as “utility.” Some BAS data files contain this missing information and can automatically discovered to assist with BAS point classification. For BAS systems missing this information the application User Interface (UI) provides manual selection from an application data table. Table 1 contains the minimum information necessary for classification of the BAS point and the common sources where the data is acquired from. As indicated in Table 1 the Client and Building information are provided by System Management and entered into an application building table.

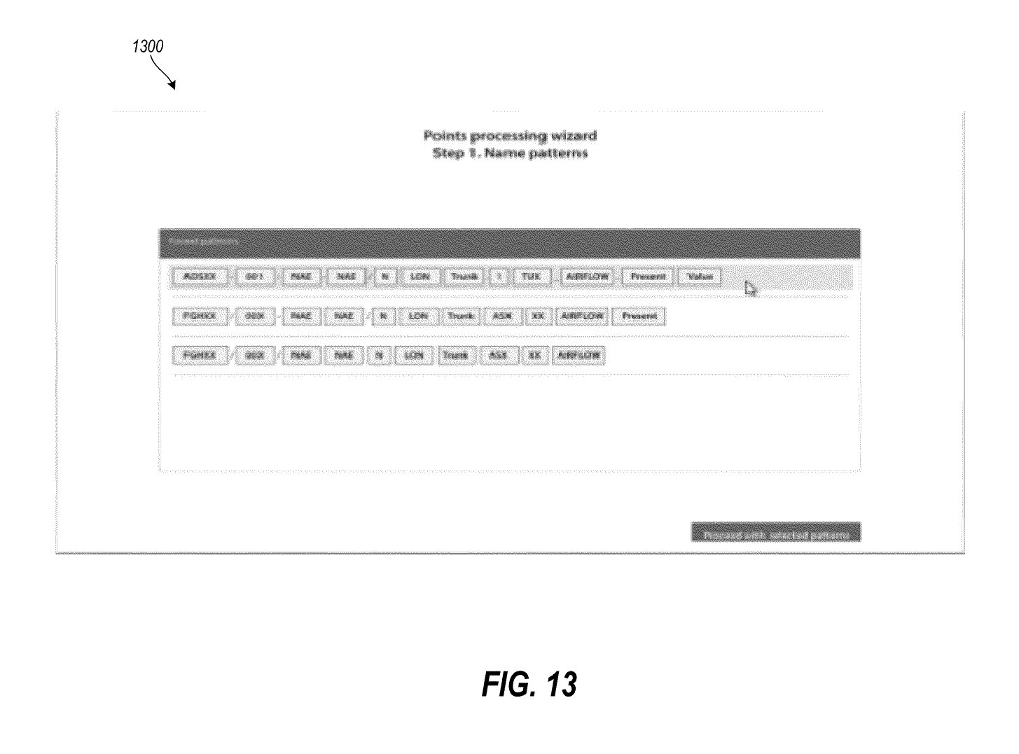

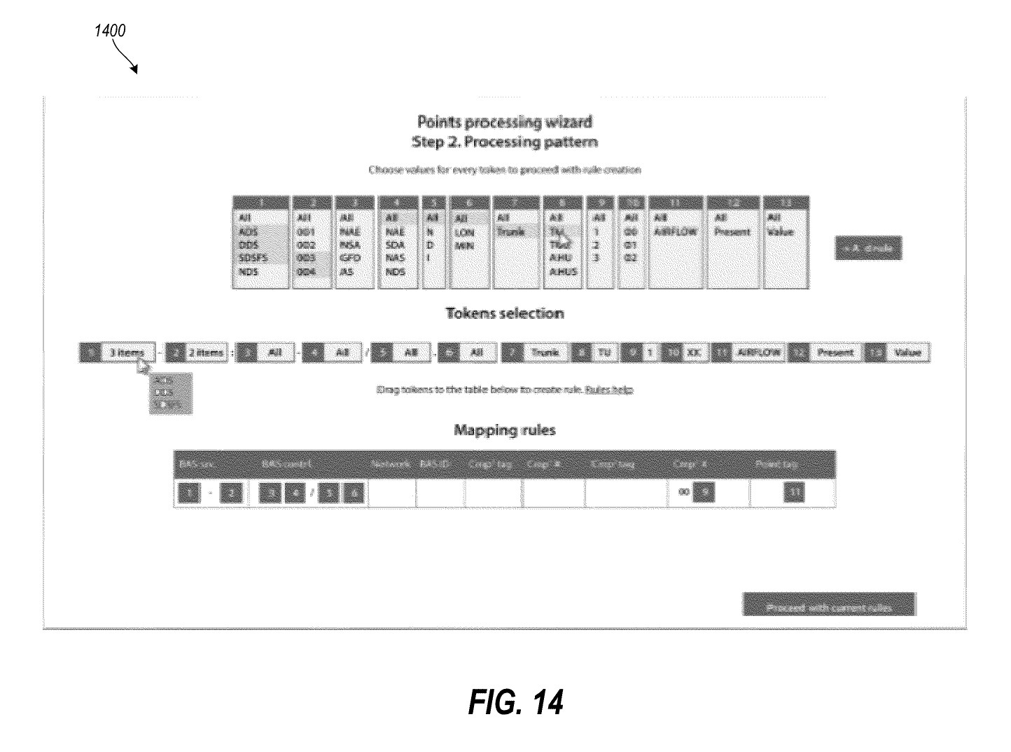

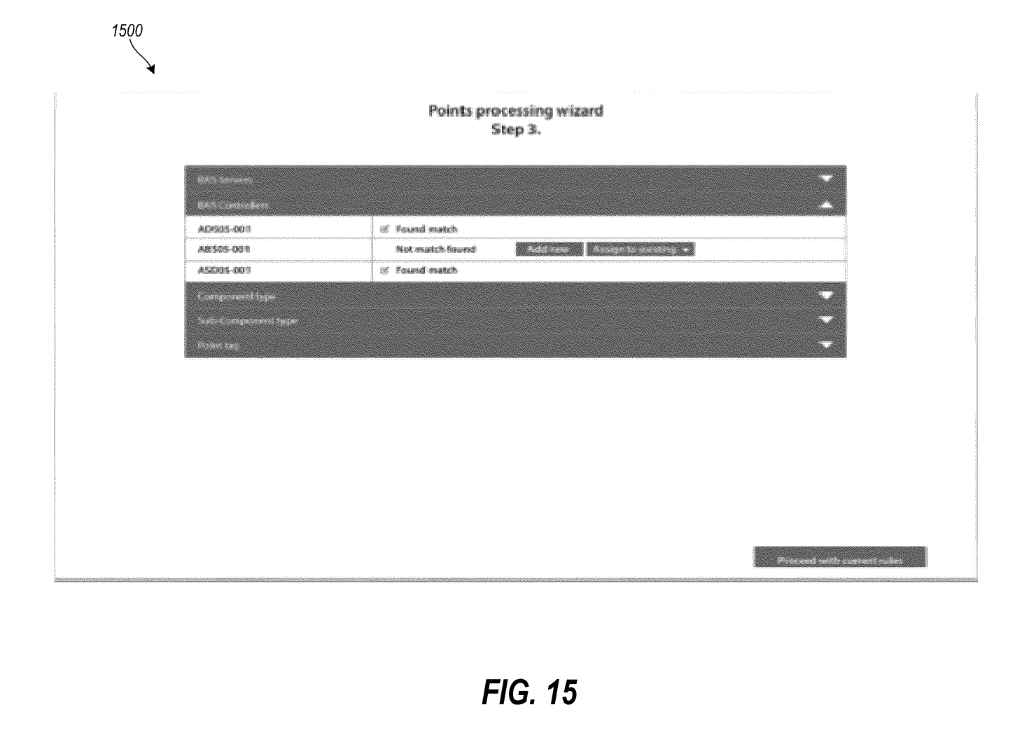

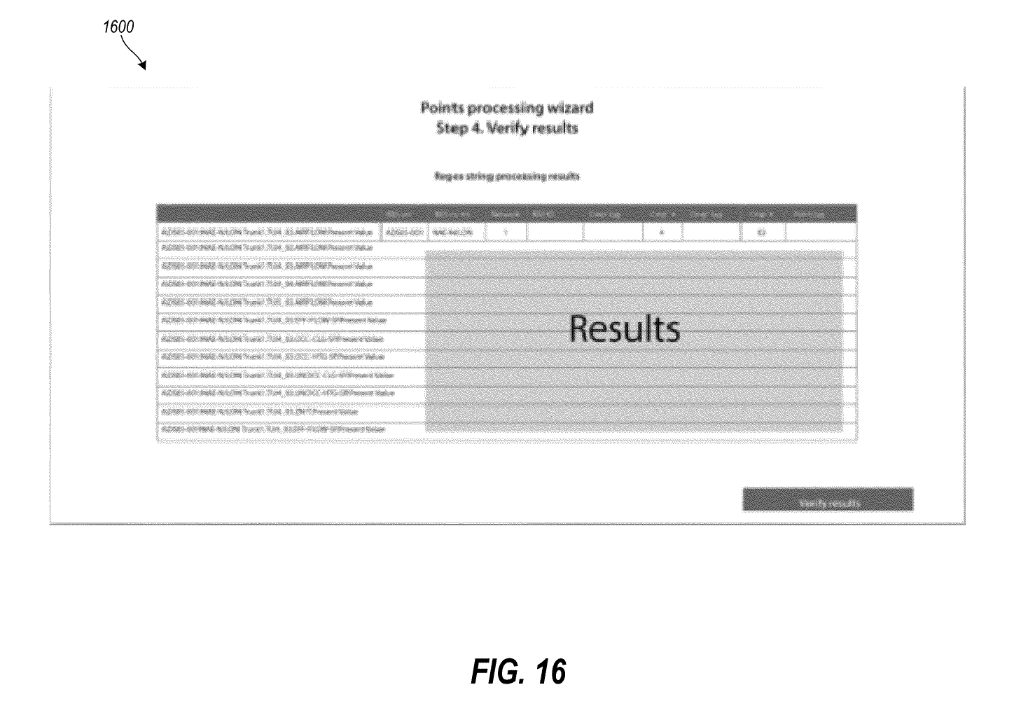

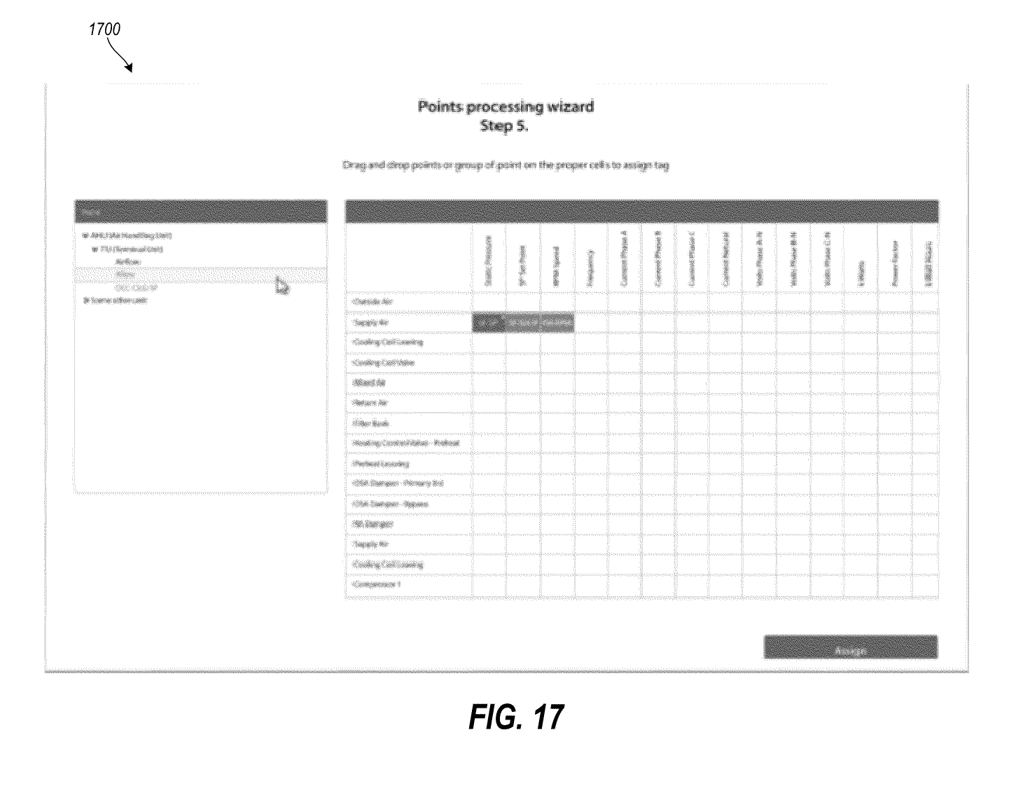

To address various acronyms for the same component type or point name by BAS programmers, the application provides a search and replace function in the BAS point translation window, see steps 1 through 5, as depicted in FIG. 13 through 17, with Step 1 in FIG. 13, diagram 1300; Step 2 in FIG. 14, diagram 1400; Step 3 in FIG. 15, diagram 1500; Step 4 in FIG. 16, diagram 1600; and Step 5 in FIG. 17, diagram 1700.

In the BAS point transformation window the application provides a routine to assign missing information and convert BAS point name acronyms to a standard acronym defined in the Point Table. The Point Table, see Step 5 example, provides unique identifier for each point within the general HVAC&R system (heating, ventilation, air conditioning, refrigeration). The Point Table Component Tag and Point Tag provide a unique identifier that is specific to the type of component and the specific component point. The Point Table is a reference table containing known HVAC components. Based on the assigned information in the BAS point translation table the application uses the information contained in the Point Table in population of the BAS Point Classification Table. The Point Table and Point Unit Table are reference tables developed and maintained by System Management to provide consistency in point naming to allow rules to run across varying naming conventions used by controls contractors. The component part and the point part of a trend point name must be categorized by Component Tag and Point Tag (i.e., 10VAV013.SA-T is the supply air for a VAV box, but VAV-12.DA-T is also the supply air for a VAV box) for processing.

TABLE 1

| Inputs | Examples | | Source of Date |
|---|---|---|---|
| Client | | | Entered at initial setup |
| Building Information | | | |
| Building Name | | | Building Table populated during setup |
| Building Location | | | Building Table populated during setup |
| Building Number | | | Building Table populated during setup |
| Central Plant | | | Building Table populated during setup |
| BAS Server | | | PointName when possible. Otherwise, App spreadsheet |
| BAS Controller | | | PointName when possible. Otherwise, App spreadsheet |
| Zone | | | Assigned through application interface |
| Subzone | | | Assigned through application interface |
| Building System Type | Chilled Water System | Air distribution | Inferred by component type |
| Component Type | Chiller | Air Handler | Extracted from BAS point name when possible. Otherwise |
| | | | assigned through application interface and point table reference |
| Component Tag | CHLR-1 | AHU-4 | Extracted from BAS point name when possible. Otherwise |
| | | | assigned through application interface and point table reference |
| Component Point Type | | Chilled water valve | Extracted from BAS point name when possible. Otherwise |
| | | | assigned through application interface and point table reference |
| Component Point Tag | | CHV | Extracted from BAS point name when possible. Otherwise |
| | | | assigned through application interface and point table reference |
| Point Information | | | |
| PointName | | | |
| DataType | Temp, pressure, energy, | | Extracted from BAS database when possible. Otherwise assigned |
| | time, etc | | through application interface and point table reference |
| PointType | static pressure, etc | | Extracted from BAS point name when possible. Otherwise |
| | | | assigned through application interface and point table reference |
| Unit | | | Extracted from BAS database when possible. Otherwise assigned |
| | | | through application interface and point table reference |
| PointTag | D-P, CP-SP | | Extracted from point table reference |

The application provides a UI for easily importing Point and Point Unit Tables updates, searching, replacing, adding, editing, and deleting Point Table Information within the UI. Access to this function requires System Management administrator credentials.

The application provides a UI for easily searching, replacing, adding, editing, deleting BAS Point Classification Table Information. Access to this function requires System administrator credentials.

The BAS point information is assembled in the “BAS Point Classification Table,” which contains all necessary information required for rapid retrieval and analysis performed by the application as described in this document. As illustrated in Steps 1 through 5 the point processing wizard translates the BAS point to populate the BAS Point Classification Table which provides the format for the BAS point Alias. The Point Table and Point Unit Table are used as reference tables in populating the BAS Point Classifications Table for all HVAC systems. The Point Unit Table will be project specific if modified by System Management. Based on the information used to classify a BAS point the application can generate an alias for the BAS point name. The alias provides a short hand version of the BAS point that is easier for humans to comprehend. The aliases provide consistency necessary for users to recognize the point affiliations and characteristics. The component tag and point tag together define the point's characteristics and can be used in querying the data used in the various levels of analysis. The alias trend point name is programmatically assigned by the application based on the BAS Point Classification Table data.

Queries by component type will align with the BAS Point Classification Table Component Tag identifier. The Points required for analysis are defined by the Point Tag associated with the specific Component Tag. The BAS Point Classification Table maintains the BAS point name, but uses the BAS point Alias in the application for consistency and speed of processing. In campus settings each BAS point name identifies the BAS server and controller and typically correlates directly to the specific building, component and component point. Each point is defined by the Component Tag and Point Tag including set points which are change of value (COV) points. Points that measure outside conditions also have unique identification through the Component Tag and Point Tag combination from the Point Table.

The application assigns an alias for each BAS point which is typically used in the application in lieu of the BAS point name, but maintains the BAS point name. The application never modifies the original BAS point name as it is the only link to the client trend point data. The BAS point name can however be queried through the application UI and if desired can be located in the BAS Point Classification Table where each field associate with the BAS point name can be viewed by System Management. The client will only see the BAS point name or Alias point name and does not have access to the BAS Point Classification Table. Client has option to select BAS Point or Alias Point naming. Editing the BAS Point Classification Table can modify the BAS point name alias if BAS Server, BAS Controller, Component Tag or Component Type, Component Point Type, Point Name or Point Tag is modified. An error message occurs if there is any inconsistence in the BAS Point Classification Table and the reference Point Table. The Alias point name contains, at least but not limited what is listed in Table 1, and the following information, Component1 Number, Component2 Number, and area served by the components as defined in the Building System Table, See Table 2.

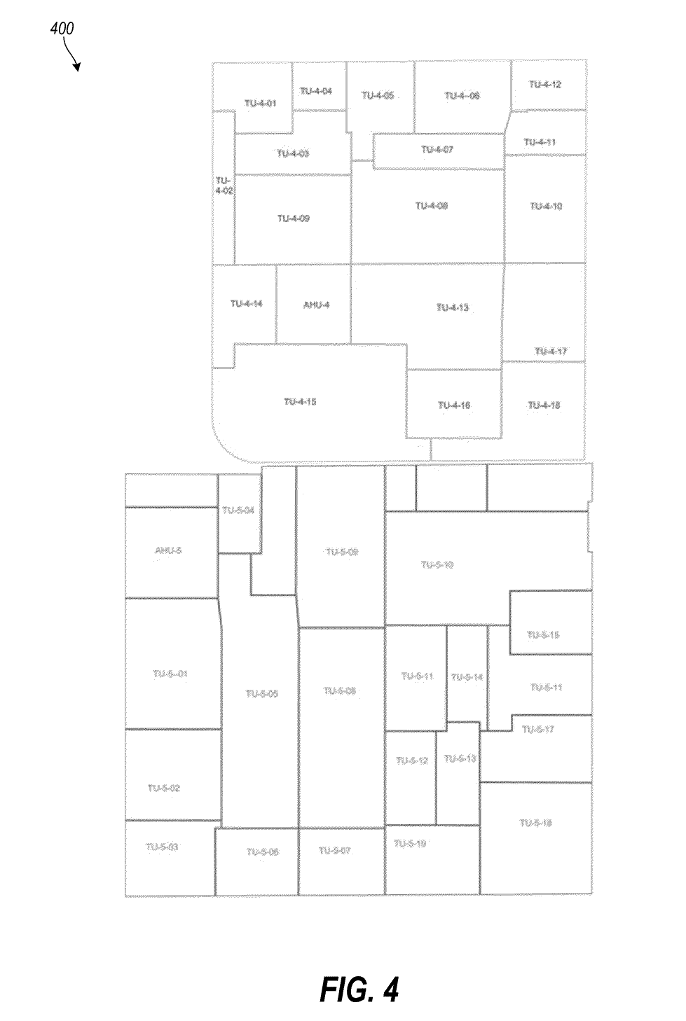

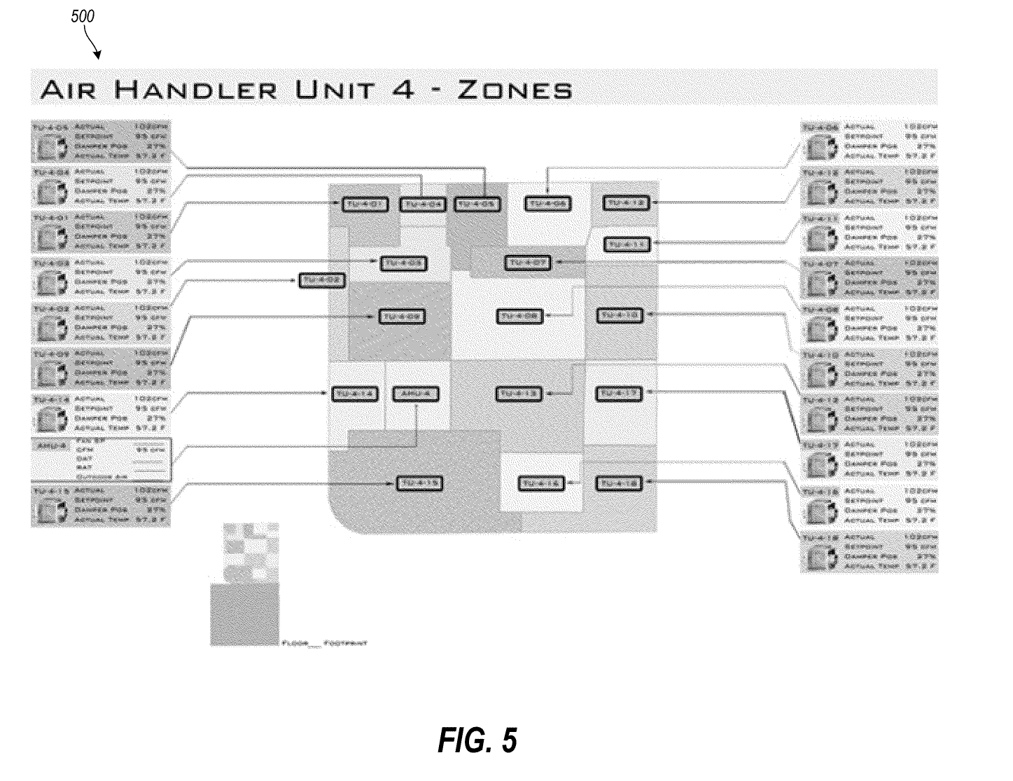

The Building Table, Table 3, illustrates the expansion of the applications building table on campuses or real estate portfolio to a Campus Building Table providing additional information used by the application. A single building would only require inputting the client name, building name, and location as all points in the BAS database would typically belong to only the one building. Several BAS controllers are required for larger buildings and would typically control sections of the building. In buildings where there are multiple BAS controllers the BAS point name contains the BAS server and controller the point is connected to. This typically also directly ties to the specific zone or subzone in the building. The full BAS point name contains that point's relationship as mapped within the BAS. BAS systems serving single buildings can have one or more controllers depending on the size of the building. Sometimes one BAS controller can be used to control the HVAC components in more than one building. The location of the specific zone or subzone in the building are located on the polygon drawings shown in FIGS. 4 and 5 which are upload to the application in the Building System Table page of the UI. Not all buildings will have polygon drawings that define the location of zones or subzones within the zone. However, the components serving the zone or subzone are defined in the building system table which allows most of level two analyses to be performed. For buildings that do not have a polygon drawings the level of analysis is limited until the drawing illustrating the location of the zones and subzones are inputted into the application. For campuses as shown in Table 3 the information needed to determine if the building has its own heating and cooling plant also comes from the “Campus Building Table”. The application UI provides a “Building Table” to provide the application the information of which BAS server and controllers belong to the individual buildings as identified in the “Campus Building Table.” The hierarchies of the components contained in the “Building System Table” are programmatically inserted based on the component or components assignments in the building system table.

The Campus Building Tables define the buildings located in a single general geographical location. The application utilizes the Campus Building Table assignments of Building System Tables to define which controllers and components belong with each building in the Campus Building Table and the areas within the building served by the building's HVAC components.

TABLE 2
Building System Table

| Building Name | | | Example 1 | Building Tag | Ex 1 | Assigned by CxGBS | | |
|---|---|---|---|---|---|---|---|---|
| Assigned Programatically | | | | | | Design | | |
| | Building | Component | | Component | | Component | | |
| Central Plant | System Type | Type | Component Tag | Number | Subsystem Order | TAG | Location | Area Served |
| Building | Chilled | Chilled | CHWL | 1 | Subsystem chwl | NA | Building | Building |
| | Water Loop | Water Loop | | | | | | |
| Building | Chilled | Chiller | CHWL-CHLR | 1 | Subsystem chwl¹ | CHR-1 | Basement Flr | Building |
| | Water Loop | | | | | | | |
| Building | Chilled | VFD Chilled | CHWL-CP-V | 1 | Subsystem chwl¹ | CP-1 | Basement Flr | Building |
| | Water Loop | Water pump | | | | | | |
| Building | Chilled | CV Cooling | CHWL-CTP-CV | 1 | Subsystem chwl¹ | TP-1 | Basement Flr | Building |
| | Water Loop | | Tower Water | | | | | |
| | | Pump | | | | | | |
| Building | Chilled | VFD Cooling | CHWL-CT-V | 1 | Subsystem chwl¹ | CT-1 | Low Roof | Building |
| | Water Loop | Tower Fan | | | | | | |
| Building | Chilled | Cooling | CHWL-CT-B | 1 | Subsystem chwl¹ | CT-1 | Low Roof | Building |
| | Water Loop | Tower Basin | | | | | | |
| Building | Hot Water | Hot Water | HWL | 1 | Subsystem hw | NA | | |
| | Loop | Loop | | | | | | |
| Building | Hot Water | Boiler | HWL-BLR | 1 | Subsystem hw² | BLR-1 | Roof-South | Building |
| | Loop | | | | | | | |
| Building | Hot Water | Hot Water | HWL-BLR-P | 1 | Subsystem hw² | BHP-1 | Roof-South | Building |
| | Loop | Loop CV | | | | | | |
| | | Pump | | | | | | |
| Building | Hot Water | Primary Loop | HWL-P-V | 1 | Subsystem hw² | HP-1 | Roof-South | Building |
| | Loop | VFD Pump | | | | | | |
| Building | Ventilation | OA Energy | DOAS | 2 | Subsystem doas | EAU-1 | Roof-South | Building |
| | | Recovery Unit | | | | | | |
| Building | Ventilation | OA VAV | OA-TU-V | 1 | Subsystem doas¹ | TU-OA-1 | Basement Flr | Basement Flr |
| | | Terminal Unit | | | | | | |
| Building | Ventilation | OA VAV | OA-TU-V | 3 | Subsystem doas¹ | TU-OA-3 | 1st Flr-South | 1st Flr-South |
| | | Terminal Unit | | | | | | |
| Building | Ventilation | OA VAV | OA-TU-V | 5 | Subsystem doas¹ | TU-OA-5 | 2nd Flr-South | 2nd Flr-South |
| | | Terminal Unit | | | | | | |
| Building | Ventilation | OA VAV | OA-TU-V | 12 | Subsystem doas¹ | TU-OA-12 | 1st Flr-South | 1st Flr-South |
| | | Terminal Unit | | | | | | |
| Building | Ventilation | OA VAV | OA-TU-V | 13 | Subsystem doas¹ | TU-OA-13 | 1st Flr-South | 1st Flr-South |
| | | Terminal Unit | | | | | | |
| Building | Ventilation | OA Energy | OOAS | 1 | Subsystem doas | ERU-2 | Roof-North | Roof-North |
| | | Recovery Unit | | | | | | |
| Building | Ventilation | OA VAV | OA-TU-V | 2 | Subsystem doas¹ | TU-OA-2 | 1st Flr-North | 1st Flr-North |
| | | Terminal Unit | | | | | | |
| Building | Ventilation | OA VAV | OA-TU-V | 4 | Subsystem doas¹ | TU-OA-4 | 2nd Flr-North | 2nd Flr-North |
| | | Terminal Unit | | | | | | |
| Building | Ventilation | OA VAV | OA-TU-V | 6 | Subsystem doas¹ | TU-OA-6 | 3rd Flr-North | 3rd Flr-North |
| | | Terminal Unit | | | | | | |
| Building | Air | VAV Air | AHU-V | 1 | Subsystem ahu | AH-01 | Basement Flr | “polygon Basement” |
| | Distribution | Handling Unit | | | | | | |
| Building | Air | VAV | TU-V | 2 | Subsystem ahu¹ | TU1-01 | Basement Flr | “polygon 1-1” |
| | Distribution | Terminal Unit | | | | | | |
| Building | Air | VAV | TU-V | 2 | Subsystem ahu¹ | TU1-02 | Basement Flr | “polygon 1-2” |
| | Distribution | Terminal Unit | | | | | | |
| Building | Air | VAV | TU-V | 3 | Subsystem ahu¹ | TU1-03 | Basement Flr | “polygon 1-3” |
| | Distribution | Terminal Unit | | | | | | |
| Building | Air | VAV | TU-V | 4 | Subsystem ahu¹ | TU1-04 | Basement Flr | “polygon 1-4” |
| | Distribution | Terminal Unit | | | | | | |
| Building | Air | VAV | TU-V | 5 | Subsystem ahu¹ | TU1-05 | Basement Flr | “polygon 1-5” |
| | Distribution | Terminal Unit | | | | | | |
| Building | Air | VAV Air | AHU-V | 2 | Subsystem ahu | AH-02 | 1st Flr-North | “polygon |
| | Distribution | Handling Unit | | | | | | 1st Flr-North” |
| Building | Air | VAV | TU-V | 1 | Subsystem ahu¹ | TU2-01 | 1st Flr-North | “polygon 2-1” |
| | Distribution | Terminal Unit | | | | | | |
| Building | Air | VAV | TU-V | 12 | Subsystem ahu¹ | TU11-12 | 5th Flr-South | “polygon 11-12” |
| | Distribution | Terminal Unit | | | | | | |
| Building | Air | VAV | TU-V | 13 | Subsystem ahu¹ | TU11-13 | 5th Flr-South | “polygon 11-13” |
| | Distribution | Terminal Unit | | | | | | |
| Building | Air | VAV | TU-V | 14 | Subsystem ahu¹ | TU11-14 | 5th Flr-South | “polygon 11-14” |
| | Distribution | Terminal Unit | | | | | | |
| Building | Air | VAV | TU-V | 15 | Subsystem ahu¹ | TU11-15 | 5th Flr-South | “polygon 11-15” |
| | Distribution | Terminal Unit | | | | | | |
| Building | Air | VAV | TU-V | 16 | Subsystem ahu¹ | TU11-16 | 5th Flr-South | “polygon 11-16” |
| | Distribution | Terminal Unit | | | | | | |
| Building | Air | VAV | TU-V | 17 | Subsystem ahu¹ | TU11-17 | 5th Flr-South | “polygon 11-17” |
| | Distribution | Terminal Unit | | | | | | |
| Building | Air | VAV | TU-V | 18 | Subsystem ahu¹ | TU11-18 | 5th Flr-South | “polygon 11-18” |
| | Distribution | Terminal Unit | | | | | | |
| Building | Air | VAV | TU-V | 19 | Subsystem ahu¹ | TU11-19 | 5th Flr-South | “polygon 11-19” |
| | Distribution | Terminal Unit | | | | | | |
| Building | Air | CV Air | AHU-CV | 12 | Subsystem ahu | AH-12 | 1st Flr-North | “polygon 12” |
| | Distribution | Handling Unit | | | | | | |
| Building | Air | CV Air | AHU-CV | 13 | Subsystem ahu | AH-13 | 1st Flr-North | “polygon 13” |
| | Distribution | Handling Unit | | | | | | |
| Building | Air | CV Air | AHU-CV | 1 | Subsystem ahu | HVU-1 | Basement Flr | Basement |
| | Distribution | Handling Unit | | | | | | Mechanical |

The Building Number and Name correlate to a specific BAS server and controller and define which controllers and their associated components and associated points are associated with each building. This information also correlates with the BAS point name and the application programmatically associates this information and the BAS Point Name Classification Table information together so that components and their associated points are assigned to the building they are located in. The Building System Table provides the location of the heating and cooling plant (building or campus), specific hierarchy of the buildings components, Component Tags, Component Number, and Designer's Component Tag which correlates with the Construction Documents the facility was constructed or remodeled with. Hierarchy of components contained in the Building System Table is a function of the Components, their component number, and the associated point classification information. The Subsystem Order column of the Building System Table provides the component grouping required for the second and third levels of analysis. The Building System Table identifies the components located in the building, their location in the building, and the areas served by the component for each building. Each building will have a Building Systems Table that provides the relationship between all components in the building and if known the areas served by each component. Components in the Building Systems Table form subsystems and these subsystems form the HVAC system that serves the building.

TABLE 3
Building Table

| | | | | | | Building Utilities | | | | | |
|---|---|---|---|---|---|---|---|---|---|---|---|
| | USA State | | City, State | | | Centrial Plant | | | | | Building |
| Client | University | Location | | BAS | Spaces | Chilled | Hot | | | | System |
| Bld No. | Building Name | Street Address | BAS Server | Controller | Served | Water | Water | Electrical | N. Gas | Propane | Table |
| | ACADEMIC | 179 Herbert St. | MSU-ADX1 | NCE66/FCB | (Insert | | | | | | (Insert |
| | COMPUTER | | | | Reference) | | | | | | Reference) |
| | LAB | | | | | | | | | | |
| | AG-BIO | 130 Creelman | MSU-ADX1 | NAE47/N2-1 | | n | n | | | | |
| | AG-BIO | 130 Creelman | MSU-ADX1 | NAE47/ | | n | n | | | | |
| | | | | THIRD | | | | | | | |
| | | | | FLOOR | | | | | | | |
| | | | | LABS | | | | | | | |
| | ALLEN HALL | 175 Presidents | MSU-ADX1 | NAE23/N2-1 | | | | | | | |
| | | Clr. | | | | | | | | | |
| | ALLEN HALL | 175 Presidents | MSU-ADX1 | NAE68/N2-1 | | | | | | | |
| | TOWER | Clr. | | | | | | | | | |
| | ALLEN HALL | 175 Presidents | MSU-ADX1 | NAE68/N2-2 | | | | | | | |
| | TOWER | Clr. | | | | | | | | | |
| | BAND/CHORAL | 72 Hardy Rd. | MSU-ADX1 | NAE35/N2-1 | | | | | | | |
| | REHEARSAL | | | | | | | | | | |
| | HALL | | | | | | | | | | |
| | BAND-A | 72 Hardy Rd. | MSU-ADX1 | NAE39/N2-1 | | | | | | | |
| | BAND-B | 72 Hardy Rd. | MSU-ADX1 | NAE39/N2-1 | | | | | | | |
| | BAND-C | 72 Hardy Rd. | MSU-ADX1 | NAE39/N2-1 | | | | | | | |
| | BOST | 190 Bost | MSU-ADX1 | NAE72/FC-2 | | n | n | | | | |
| | EXTENSION | | | | | | | | | | |
| | BOST | 190 Bost | MSU-ADX1 | NAE72/N2-1 | | n | n | | | | |
| | EXTENSION | | | | | | | | | | |
| | BOWEN HALL | 456 Hardy Rd. | MSU-ADX1 | NAE8/N2-1 | | y | y | | | | |
| | BOWEN HALL | 456 Hardy Rd. | MSU-ADX1 | NAE8/N2-2 | | y | y | | | | |
| | BRISCOE HALL | 120 Gamer Clr. | MSU-ADX1 | NAE17/N2-1 | | n | n | | | | |
| | BRYAN HALL | 288 Lakeview | MSU-ADX1 | NAE36/N2-1 | | n | n | | | | |
| | | Dr. | | | | | | | | | |
| | BUTLER HALL | 565 George | MSU-ADX1 | NAE51/N2-1 | | n | n | | | | |
| | | Perry St. | | | | | | | | | |
| | CARPENTER | 479-1 Hardy | MSU-ADX1 | NAE62/N2-1 | | y | y | | | | |
| | HALL | Rd. | | | | | | | | | |
| | CAVS | 200 Research | MSU-ADX1 | NAE1/N2-1 | | | | | | | |
| | | Blvd | | | | | | | | | |
| | CHAPEL | 135 Walker | MSU-ADX1 | NAE55/FC-1 | | | | | | | |
| | OF MEMORIES | Rd. | | | | | | | | | |
| | CLAY-LYLE | 100 Old | MSU-ADX1 | NAE56/FC-1 | | n | n | | | | |
| | | Hwy. 12 | | | | | | | | | |
| | COBB | 340 Lee Blvd. | MSU-ADX1 | NAE19/N2-1 | | y | y | | | | |
| | INSTITUTE | | | | | | | | | | |
| | COLVARD | 198 Lee Blvd. | MSU-ADX1 | NAE45/FC-1 | | y | y | | | | |
| | STUDENT | | | | | | | | | | |
| | UNION | | | | | | | | | | |
| | COLVARD | 198 Lee Blvd. | MSU-ADX1 | NAE45/FC-2 | | y | y | | | | |
| | STUDENT | | | | | | | | | | |
| | UNION | | | | | | | | | | |
| | COOLEY | Sold | MSU-ADX1 | NAE16/N2-1 | | n | n | | | | |
| | BUILDING | | | | | | | | | | |
| | CRESWELL | 36 Magruder | MSU-ADX1 | NAE73/FCB | | n | n | | | | |
| | HALL | St. | | | | | | | | | |
| | CULLIS- | 75 B.S. | MSU-ADX1 | NAE28/N2-1 | | n | n | | | | |
| | WADE | Hood Dr. | | | | | | | | | |
| | DEPOT | | | | | | | | | | |
| | DAVIS- | | MSU-ADX1 | NAE21/N2-1 | | n | n | | | | |
| | WADE | | | | | | | | | | |
| | STADIUM | | | | | | | | | | |
| | DIAL-ICET | | MSU-ADX1 | NAE42/N2-1 | | n | n | | | | |
| | DORMAN HALL | 32 Creelman | MSU-ADX1 | NAE49/N2-1 | | n | n | | | | |
| | | St. | | | | | | | | | |
| | EVANS HALL | 90 Evans Clr. | MSU-ADX1 | NAE69/FCB | | | | | | | |
| | GARNER HALL | 88 Gamer Clr. | MSU-ADX1 | NAE33/N2-1 | | | | | | | |
| | GEORGE HALL | 233 Lee Blvd. | MSU-ADX1 | NAE32/N2-1 | | | | | | | |
| | HAND CHEM | 310 Presidents | MSU-ADX1 | NAE9/N2-1 | | y | y | | | | |
| | LAB-NEW | Clr. | | | | | | | | | |
| | HAND CHEM | 310 Presidents | MSU-ADX1 | NAE9/N2-2 | | y | y | | | | |
| | LAB-NEW | Clr. | | | | | | | | | |
| | HAND CHEM | 310 Presidents | MSU-ADX1 | NAE10/N2-1 | | y | y | | | | |
| | LAB-OLD | Clr. | | | | | | | | | |
| | HARNED HALL | 295 Lee Blvd. | MSU-ADX1 | NAE77/FC-1 | | | | | | | |
| | HARNED HALL | 295 Lee Blvd. | MSU-ADX1 | NAE77/FC-2 | | | | | | | |
| | HAWTHORN | 76 Magruder | MSU-ADX1 | NAE74/FCB | | | | | | | |
| | HALL | St. | | | | | | | | | |

Using the Building Systems Table the application aligns the components and equipment that serve the building in the correct hierarchical order. The inference is that if a component is in a subset component then it is also a subset component of any higher components. The Building Systems Table, Campus Building Table, and BAS Point Name Classification Table allow data to be correctly recognized for analysis. The alias name contains information that allows humans to easily recognize the BAS point and its relation to the building and components that makeup the system serving the building.

Analysis

First Level of Analysis

The first level of analysis is identification of operational flags (OF) within the application. The first level of analysis is at the component level using rule based algorithms to identify potential issues for reporting or further analysis. The application's UI provides a window where a rule is defined. In the rule definition window the System Management/Programmer selects the component type that the rule will apply to by selecting the Component Tag from a drop down menu based on the Component Tags illustrated in the Example Tables. Selection of the Component Tag auto selects the rule number associated with the specific Component Tag. The rule number will be consecutive in order. The System Management/Programmer inserts the rule name, description, formula, confidence formula (if determined), and the inputs required for the rule to run. The inputs are points selected from a dropdown menu of points associated with the specific Component Tag. The dropdown menu contains the Point Tags for the specific Component Tag contained in the Point Table (See Example Tables spreadsheet). The rule is saved to the Operational Flag/Issue Definition Library. The Operational Flag/Issue Definition Library lists all rules in the library. From the Operational Flag/Issue Definition Library page rules can be selected to run (Active) or not run (Archived), be modified, or deleted. When a rule is developed and saved the UI automatic turns the rule active. Rules identify possible OF. The component or groups of components that have been flagged are grouped by rule type for additional analysis to further quantify the OI specifics or if no additional analysis is required the result is to report the OI. New rules are tested against a known database containing a specific sample set before the rule is made active to reduce false operational flags or issues. The ability to undo the results on an analysis if discovered to have an error is provided by the application covering the period the rule was active. The Operational Flag/Issue Definition Library will be the basis for each client's individual to allow use of previously developed analysis programming. Once the Operational Flag/Issue Definition Library is edited it becomes unique to the client. Only new definitions are added to the global Operational Flag/Issue Definition Library.

The first level of analysis runs all active rules contained in the Operational Flag/Issue Definition Library. Prior to running the rules contained in the Operational Flag/Issue Definition Library the application will check that the input Point Tags required by the Component Tag rule are present in the database. A Component Tag that has a missing Point Tag input will results in no analysis due to the component analysis rule missing the Point Tag or Tags, and will store a record of each incomplete instance and associated missing Point Tag or Tags. The application UI provides a window that displays each incomplete instance with the information contained in the Incomplete O Flag Instances defined. Double clicking on either the BAS point name or alias would take the user to the BAS Point Classification Table row where the BAS point information is stored for review and possible modification. A sample of an Operational Flag/Issue Definition Library is contained in the Example Tables spreadsheet.

Rules are written for each component type, e.g., a rule written for VAV Terminal Unit (Component Tag TU-V) could also apply to variations of the component type VAV Terminal Unit Series (TU-V-S) or VAV Terminal Unit Parallel (TU-V-P). When defining the component type rule System Management/Programmer uses the Component Tag. A component tag e.g., TU would run the rule on components with TU included in their Component Tag. A component tag of TU-V would only run the rule for components with TU-V included in their Component Tag. The same logic would apply to TU-V-S or TU-V-P where the specific Component Tag characters contained in the Component Tag must be present in the Rule Definition. The rule type defines the Component and Point Tags required for the component specific rule to run. Components with the required rule Point Tags are analyzed using the associated BAS point name trend data.

Data Alignment

Two formats are used. The first format aligns all data at the same time interval, i.e., 15 minute intervals concurrent in time. This creates a problem as COV values are written when they actually occur and often do not coincides with the same scheduled time interval, i.e., 15 minute point records. This requires that COV data be written to the application database in accordance with the first format using the last know value at each scheduled time interval, i.e., 15 minute. This also creates a problem if data being trended have different sample rate. Using a 10 minute sample rate the trend data would only align with 15 minute sample on the hour and half hour. The System also flags sample rates that are not in alignment with the majority of scheduled point samples and not simply adjusted or fitted into 15 minute sampling by using the last previously known data sampling. The trend point value at 3:10 cannot be used at 3:15 for a valid trend point data. Although not desirable, a 5 minute sampling would provide good trend data if only the 15 minute trend data samplings were fitted into the Application database.

The COV data is also written in a second format which records the COV data as it occurs in time and is stored in the BAS trend database. Both formats are selectable from the analysis dashboard for the COV data.

Data Voids. Data voids should be minimized but are not unavoidable. The System processes the following three conditions:

Data contained in the BAS trend database but not written to the Application database due to excessive data writes. Excessive writes are defined as exceeding 150 records in 24 hour period.

For “excessive data write” points contained in the BAS trend database the value recorded either at the coincident time or the last value recorded would we written to the Application database and these values point name shall be displayed in red type if they fit the definition of “excessive writes” or in green if they are 5 minute intervals.

Change in system that eliminates a point or renames it in the BAS trend database shall result in an error flag for the associated point name stating “Data Missing.” This will alert System Management of the issue for action.

System malfunctions can causes data too temporarily (hours, days, etc.) not to be recorded into the BAS trend database.

Depending on the point type, an algorithm in the application will fill in voids. The System documents when the data becomes missing by identifying the beginning and ending time periods of missing data. The algorithm is designed to interpolate and write missing data to the database in the void areas. The interpolated data is displayed in orange text.

The application UI allows selection or de-selection of component rules that will be used for analysis for each client. The de-selection flag remains deselected until System Management reselects the rule once de-selected. Typically, all component rules contained in the Operational Flag/Issue Definition Library will run on an ongoing basis.

The application after initial setup and classification of BAS points run analysis on an ongoing basis starting from the earliest date of data up to the most current data. The application UI indicates the date range of data in the analysis for each point and reruns the analyses on BAS points from the earliest date of available data when rules are added or modified. The re-analyses are limited to the components affected by the rule addition or modification. After the initial analyses using the full data set, the application limits analyses to new data received from the System Agent. The results of the analysis are added to the first level of analysis reports. Modifications to the BAS Point Classification Table, Building System Table, or Campus Building Table would automatically cause the component rules using the modified point to rerun the analyses for the associated component type.

The results of complete and incomplete analyses from the first level of analysis are reported in the Operational Flag/Issue Definition Library page as defined. The application UI provides tables for Complete Instances; Incomplete Instances and Missing Points; and components not analyzed due to missing Point Tag for review by System Management to determine if the rule should be modified or a new rule should be added to analyze the variant component. The Incomplete Instance report is used to track down missing information or misclassification of points. Modifications as defined result in reanalysis of affected components.

As defined the first level of rules define operational flags (OF) which identify potential problems, but they require further analysis to determine the specific operational issue. Level one rule's are designed for specific component types as defined by their Component Tag. Completed OF instances identify which components are flagged by the OF function. These components are grouped by component and OF rule number for further analysis. Several levels of analysis may be required to establish the OI. The application provides a window for each level or order of additional analysis. In each level of the application, the UI provides a page where conditional statements, equations, comparisons using BAS points, etc. can be formulated to determine the operational issue and the ability to add statistical formulas. The statistical formulas and their results are used to determine the frequency of an OI which are factored into the building health index and financial calculations. Each order of analysis is saved in the Operational Flag/Issue Definition Library by component type and order of analysis. Each component and associate OF combination has additional analysis windows where conditional formulas can be entered, also saved in the Operational Flag/Issue Definition Library. The results from each level of analysis are divided into two groups. The first group is operational issue classified and the second group is operational issue unclassified. For each unclassified operational issue group (OI) the application provides a similar window as described at the beginning of analysis to classify the OF into an OI. For “OFs” that are classified into OIs the application provides a report language filed where a narrative can be written which will be used to populate the report fields. These fields have Rich Text, automatic spelling and grammar function to assist with reporting the OI. The remaining unclassified OFs are reviewed by System Management and have a no additional analysis is required check box. System Management will review the OF results and determine if the OF should proceed to reporting or to further analysis. If the “no additional analysis” box is checked the application provides a reporting field where the report narrative is written. The application provides System Management the opportunity to select and deselect this option. When this option is selected the option will remain functional until it is deselected. When the option for addition analysis is selected System Management will craft a conditional statement the application will use to analysis the specific component OF type. The application UI provides the ability to write these conditional statements and assign them to run against specific OF results. Each order of further analysis of an OF will run the conditional statement against only the associated components flagged by the OF rule or conditional statements/formula. The results of both OFs and OI will contain the results and the specific start and end date associated with the OF or OI. Based on the parameters associated with the OI category cost estimating algorithms will assign financial magnitude to the OI which will be used in both reporting and calculating the overall health of the building/facility. The OI category will have standard report language for inclusion in the report. The application provides a location to insert and store language associated with a specific OI and when selected to report will write the stored language into the defined report format.

The second level of Operational Flag (OF) analysis is subsystem analysis. The application provides a second level set of programming windows where the Building System Type components are grouped together for analysis. The groupings of components are organized by the Subsystem Order as defined in the Building System Table. As shown in the Building System Table, the top level subsystems are subsystem chwl, subsystem doas, subsystem ahu, and subsystem hw, etc. The application UI provides the ability to add or subtract subsystems as defined in the various tables. The Building Systems Table components are associated with one of the top level subsystems listed in the Table. Each Component Tag listed under the top level subsystem is assigned a subsystem hierarchy represented by the superscript at the end of the subsystem type i.e., subsystem chwl¹, subsystem chwl², etc. The lower the subsystem superscript numbers, the higher the component ranks in order of component hierarchy. Each top level subsystem has no superscript assigned in the Subsystem Order column. The Component Number Table indicates the number of top level Subsystems of the same or similar type i.e., top level subsystem ahu has Component Numbers 1 to 13 as is the case illustrated in Table 2. The programmatically populated Component Number column is from the BAS Point Classification Table. The application UI provides a window where individual top level subsystems are selected to be displayed.

The application UI provides a window where the Building, Building System Type, and top level subsystem are selected for analysis. Based on the selection, the UI displays a tree configuration based upon the selected parameters and subsystem order of the component contained in the Building System Type from the Building System Table. The components in the tree display a table adjacent to the Component Tag that displays the Point Tag, Point Value, and Point Units associated with the component, similar to the tables shown in FIG. 5. The application provides a window where logic statements, formulas, etc. can be entered to create Operational Flags and Operational Issues definitions similar to the process described that creates analysis definitions, except that it is a subsystem analysis definition that is created and stored in the Operational Flag/Issue Definition Library under “Subsystems.” The application provides a library of graphics that can be imported into page were the Component Tag is shown in the tree and arranged with the Component Tag. Only Point Tags with recorded values are displayed in the Table. The Building System Table page in the UI provides uploading of polygon drawings that will be used to provide graphical communication of issues to clients. In the Building System Table page, the UI provides mapping of components and their points to the polygon drawing as illustrated in FIG. 4 and graphics associated with the components as illustrated in FIG. 5 are uploaded for developing dashboard pages.

Components that make a system in the building are connected through the Building System Table. The Building System Table lists each subsystem that together makeup the entire heating ventilation and air conditioning system (HVAC). The Building System Table contains each major or top level building system type in the Building System Type column, the location of the components and the relationship between its components. The Building System Table, Table 2, indicates the Building System Type, top level subsystem and the dependent subsystems. The hierarchies of the Subsystems are represented by the superscript variable in the Subsystem name located in the Subsystem Order column. Building System Type column and the top level component i.e., “Air Handling Units” listed in the Component Type column occupy the top level of the Subsystem order as represented by a name without a superscript variable in the subsystem name. The Subsystem Order column indicates the hierarchal level for each component listed i.e., “subsystem ahu” is a specific air handler in the building and represents the air handling unit “AHU-1” as the highest order in the subcategory as indicated.

“Subsystem ahu1” are subcomponents of the air handling unit, which constitutes a single piece of equipment with many parts, and represents the inner components that makeup the specific air handler. “Subsystem ahu2” represents the components that are served by Subsystem ahu and its components Subsystem ahu1. The superscript in the subsystem naming protocol indicates the hierarchal level of the component in the subsystem. The higher the subscript number the lower it resides in the hierarchal tree. Table 2 illustrates how components are grouped and the hierarchical relationship between the components.

The HVAC system for a building is a composite of its subsystems. Table 2, the Building Systems Table, connects the HVAC system components and their associated points contained in the building into their appropriate associations and hierarchy to allow analysis of the entire subsystem and well as the interaction with supporting subsystems the comprise the whole HVAC system. The 1st column “Central Plant” in the Building System Table, Table 2, indicates that the heating and cooling infrastructure, Hot Water Loop and Chilled Water Loop and all of their components are located in the building. If the chilled water and hot water systems were being provided by a central plant located in a different building the Central Plant column would list Campus. Because a campus can have multiple central plants, depending on its size, the “Campus” can have a number associated with it such as Campus 1, Campus 2, etc. The Building System Type indicates which building subsystem is located in the building or other building on campus. The Building System Type column indicates the subsystem category. The Subsystem Category Order column indicates the hierarchal order within the Building System Type. The Designer Component Tag column provides the subcomponent identification within the building as shown on building design documents. The Location column indicates the general location of the subcomponent in the building, and the Area Served provides the portion of the building served by the component, except of air handlers and terminal units which map directly to a floor plan drawing (polygon). The interconnection of systems is indicated in the Building System Type, Component Tag, and Subsystem Order columns.

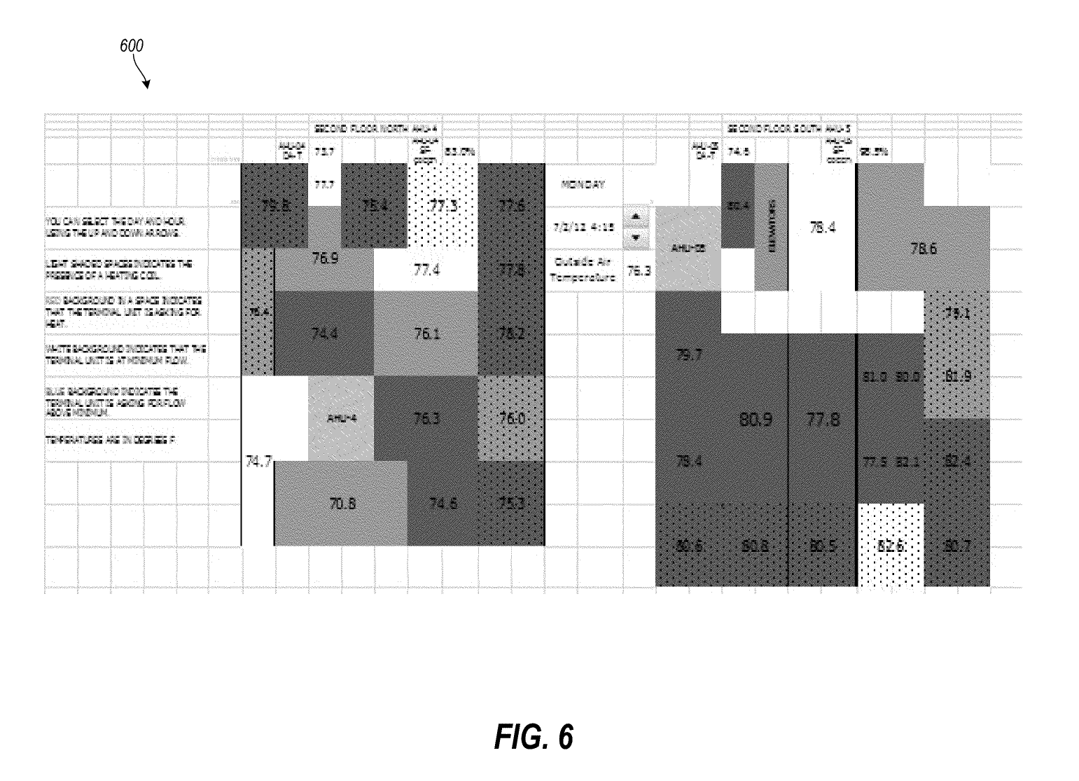

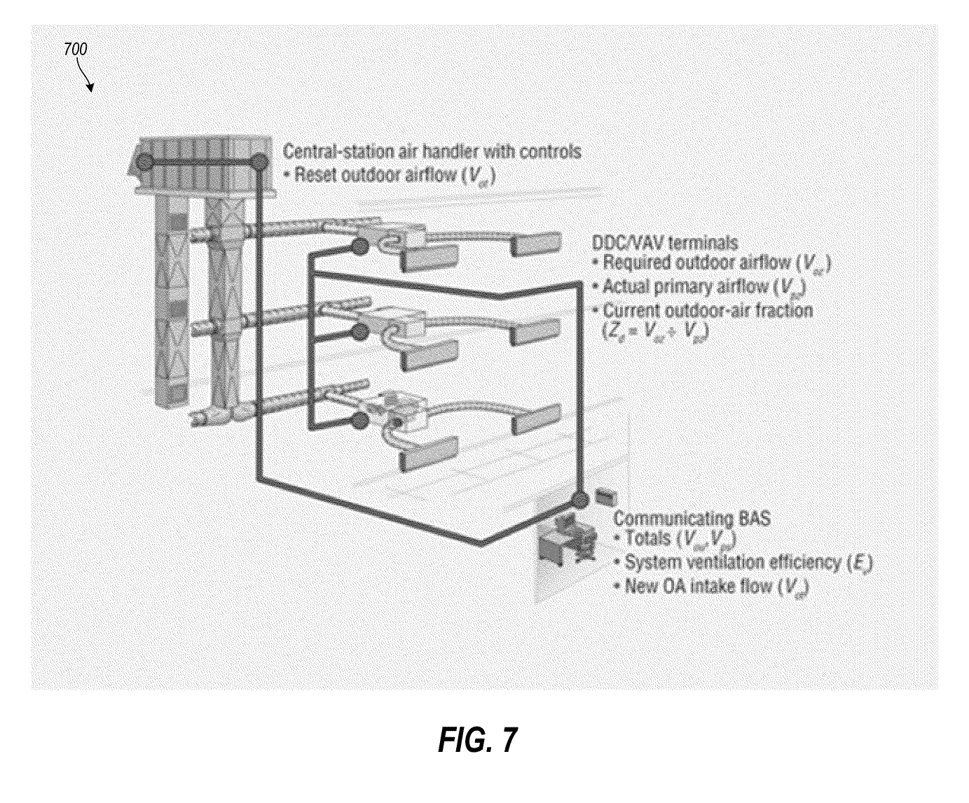

Table 2 also indicates the subcomponent terminal units (TU) served by AHU-1 and the “Area Served” sections that contain the reference to the polygon as illustrated FIG. 4. Also indicated is that the air hander serves a zone and the terminal boxes serve the subzones in the zone as illustrated in FIG. 7, diagram 700. The air handler its subsystem components the TU are also mapped to the individual polygons in the floor plan defining the zone and the subsystem component terminal unit serving the specific subzones as shown in FIGS. 4 and 5. The second level of analysis uses the selected points belonging to the sum of components that are part of the top level subsystem and analyzes the interaction of these components as a whole top level subsystem as shown in FIGS. 5 and 6. The section of a top level subsystem, grouping of its components, and selection of BAS points which will provide the information for the analysis is described. Communicating issues to clients is provided through reporting functions similar to the reporting described plus the use of graphics illustrated in FIGS. 5 and 6 to help communicate the problem for inclusion in reports generated by the application. In addition to the levels of analysis described the second level of analysis will include the use of graphical recognition to help create OF and OI flags.

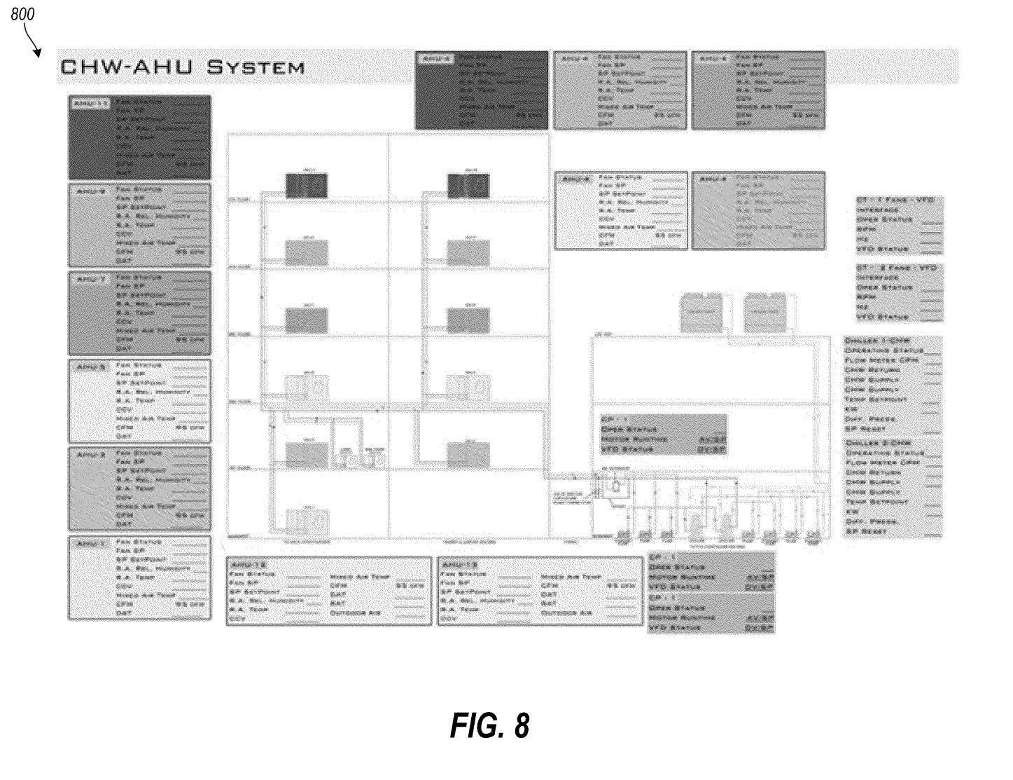

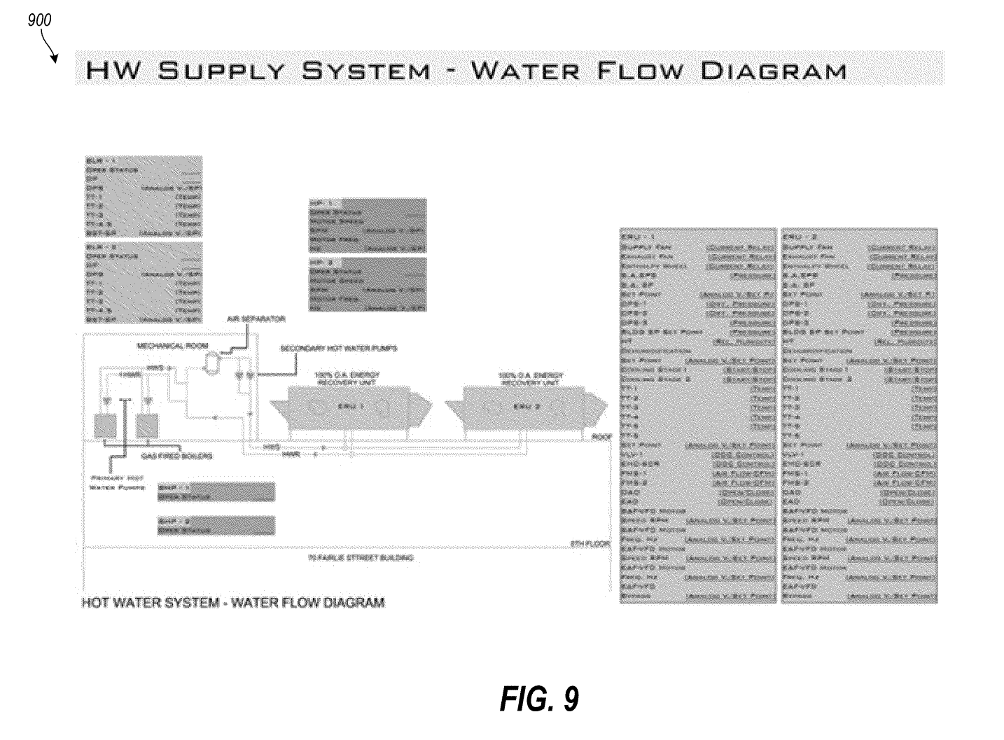

The third level of OI analysis expands analysis from individual top level subsystems to pairing of top level subsystems contained in the Building System Table and can be extended to top level subsystems contained in other associated Building System Tables. Buildings that do not have top level subsystems outside the building will only include analysis on the top level systems contained in the Building System Table. When a top level subsystem such as chilled or hot water is located in a central plant these systems will be included in the central plant Building System Table thus requiring paring between Building System Tables for analysis. The Building System Table indicates in the Central Plant column if the building receives services from another building i.e., Central Plant as indicated in both Table 2 and 3. The Building System Table, Table 2, identifies the top level subsystems as described. The third level of analysis provides a programming window similar to the description where top level subsystems are presented in the form of a tree that follows the Subsystem Order column in the Building System Table when an individual top level system is selected. In the third level of analysis multiple top level subsystems can be selected each represented in a tree format. The connections between the top level subsystem trees are defined in the Building System Table by the Building System Type column. When two building system types are listed in the same cell, it indicates the connection point between the two top level subsystems. In the application programming window, there is an option to upload graphics either from the application's graphics library or a file from outside the application. The subsystem tree components and points can be mapped to the graphic which results in a display as shown in FIG. 8, diagram 800. FIG. 8 provides an example of how subsystems types such air handling units (ahu) relate to other systems such as chilled water loop (chwl). FIG. 8 illustrates a typical chilled water loop that provides chilled water to all of the air handlers in the building. FIG. 9, diagram 900, provides yet another illustration where outside air unit (DOAS) provides outside air to all of the air handling units in the building. This level would join, if selected, FIGS. 8 and 9 for analysis or it could joint all of the top level subsystem air handling units in all of the buildings served by a specific central plant for analysis. Similar analysis programming, saving and reporting functions as described would be part of this analysis level. Since this level of analysis can have several combinations each analysis is programmed by System Management based on the specific desired parameters to be analyzed. Each analysis type shall be given a specific name and saved in a master list that can be selected to run on and ongoing basis, scheduled or when a specific set of conditions are present based on a conditional statement. The analysis of multiple Building System Types are set up in the Multiple System Analysis window, a programming window in which the selected top level subsystem Building System Types will display as a described above. To facilitate programming the components and point tags of the selected top level, subsystems are displayed for selection in writing the conditional statements and formulas that will be used to analyze the selected components to generate operational flags and operational issues. The communication of issues to the client will be similar to previous sections of this document. FIGS. 8 and 9 provide an example of the type of graphics used to convey information to the client. As shown in FIG. 8 all of the top level, i.e., “subsystem ahu”, are graphically displayed with their table of associated Point Tags. The imported graphic mapping has the components points mapped to the graphic. The UI provides placement of tables by System Management with selected point information in the appropriate location of the uploaded graphic. The table information associated with the top level subsystem is limited to Point Tags associated with the subsystem components one level below the top level subsystem i.e., subsystem ahu¹. The UI provides a means of scaling the graphic and placing the appropriate table adjacent the top level subsystem component. The Point Tag table associated with the top level subsystem components will allow select and deselect of Point Tags to be displayed in the table.

Level four of the OI analysis provides detailed analysis of the operating efficiency of the components within the HVAC system, such as the chiller, boiler, cooling tower, pumped loops, and air handlers. This level provides a programming window where components being analyzed are selected and their associated points defined by the selected Component and Point Tags, weather data, and operational schedules, and other available data are used in the analysis algorithms. Similar to other programming windows described in earlier sections logic, statements, equations, and statistical formulas are entered in the programming window. Reporting also follows the previous descriptions provided. A graphic of the component is displayed and the application allows results of the equation to be shown in the client dashboard as well as being included in client reports that are automatically generated.

Level five of the OI analyses are whole building analyses that includes elements from levels two through four and building characteristics, population profiles collected by an agent, weather information from the national weather service or designated weather station, submetering data from either the building automation system or separate data logging system that writes the metered data to a central database and collected by a System agent. The System application provides a table to input building characteristics that are used in calculation of the measurement and verification baseline and the various levels of analysis for each building. The data from the building characteristics is correlated to each building through Building System Table. Similar to the assignment of polygons in the Area Served column of the Building System Table building Characteristics will also be assigned. The population profile data can come from several different sources. For single building applications the System application provides a table where System Management can enter the number of occupants into each zone on an hourly basis or from and electronic set of devices that count the number of people within a space and writes this data to a database, or imports data from the owner's database through a System Agent. In a university campus settings the population profile will come from the registers database where the number of students registered for a class, the class meeting time, and class location are recorded and written to a database. The application correlates the population in each zone and subzone on an hourly basis for use in the level five analyses. Weather data information is available online from NOAA National Weather Service and is imported for calculation purposes on an as needed basis. The System application using weather data calculates heating and cooling degree days that will be stored in the application for benchmarking functions explained in more detail under “Benchmarking” section of this document. Whole building metering and submetering used in analysis, baseline measurement and verification and benchmarking from both the building and utility sources is described in the “Metering” section of this document.

Level six of OI analyses includes correlating occupant survey results with analytic results that identify OF and OIs to determine the health calculation of each building.

Financial Analysis

Each of the levels of analysis will have calculations associated with the OIs. The application provides the ability to insert equations at each analysis level in the programming window and using point information to calculate and estimated costs associated with the OIs identified. This information is written to the reports. Actual results are calculated using the predictive baseline performed as part of the measurement and verification baseline development against actual utility and work hours/task described.

Analysis Library

As analyses are developed and saved the rules, equations, conditional statements, and system configurations are stored in a library that can be accessed and used with appropriate editing for other clients or buildings within a client's ownership.

Reporting

Each level of analysis will have an associated category of information that will be divided into four client levels of reports, providing specific information based on the organizational level receiving the report. The four levels are the executive level, facility management level, resource management level, and the technician/contractor level. Within each level will be daily and weekly reports that provide daily and weekly information and monthly and yearly summary reports that provide an ongoing summary. Additional levels of reporting will include two levels: System Management and selected System vendors. Each type of report will use a template similar to Microsoft Word capabilities. The report format templates will pull selected information from the results generated by the application analyses, population profiles, weather information, utility usage, metered and submetering, benchmarking calculations, financial analysis, and statistical analysis information, etc. for inclusion in the clients report. System Management and System vendor reports can include all of the client type of information and additional summary of System Vendor clients and all clients within the System application.

The application will automatically generate these reports on a scheduled basis as determined by System Management, System Vendor, or client. The report window within the application will have a recurring report window that allows selection of daily, weekly, monthly, and yearly reporting similar to the Microsoft recurring appointment function in Microsoft© Outlook.

Based on the level of access i.e., System Management, System Vendor, or Client only specific report templates will be available. System Management will have access to every level within the System Application, but lower levels i.e., will only have access to information associated with their respective levels. The reporting function shall provide flexibility in assignment of which report templates each level will have access to from a global level through the three client levels.

The application reporting function provides for summary reports to be issued monthly and annually in addition to the daily and weekly OI associated reports. The applications reporting function facilitates development of reports using standard report format templates and/or custom report development using Microsoft Word for each level of reporting and to be automatically populated with information based on the OIs identified.

The reporting function within the System application will provide fields for narratives associated with results from the identified OIs, and analyses are inserted and used to populate the reports in accordance with the template format and data fields. Where application graphics are desired to be included a graphic windows will be inserted into the report format with the graphics file name and associated data in the report.

Dashboards

Access to the System will be through dashboards. User level access dictates the type of information and tools available to the user. Every user will be assigned a level of access. System Management will assign user accesses during client setup, which will correlate directly with the information, to be displayed and accessible through the dashboard.

The Client Dashboards

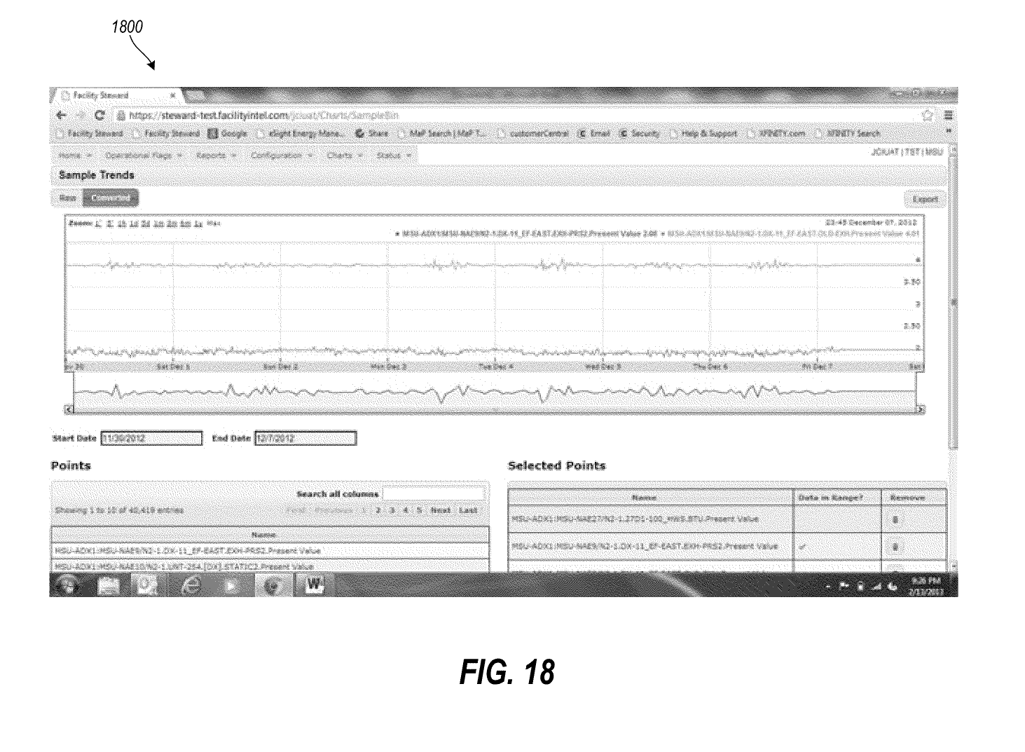

The System provides a web portal that provides access to all available points from the Client's Building Automation System. The client selects up to points 16 points at a time and the time period of data from the webpage. See Sample Trends graphics in FIG. 18, diagram 1800.

In a campus setting with multiple buildings, the buildings controlled by the BAS are inputted into a “Building Table (see Table 3). The Building Table contains the Building Number, Building Name, Address, BAS Master Server, BAS Controllers, if connected to a central plant, utility meter type and meter number, and a reference to the Building System Table associated with the building.

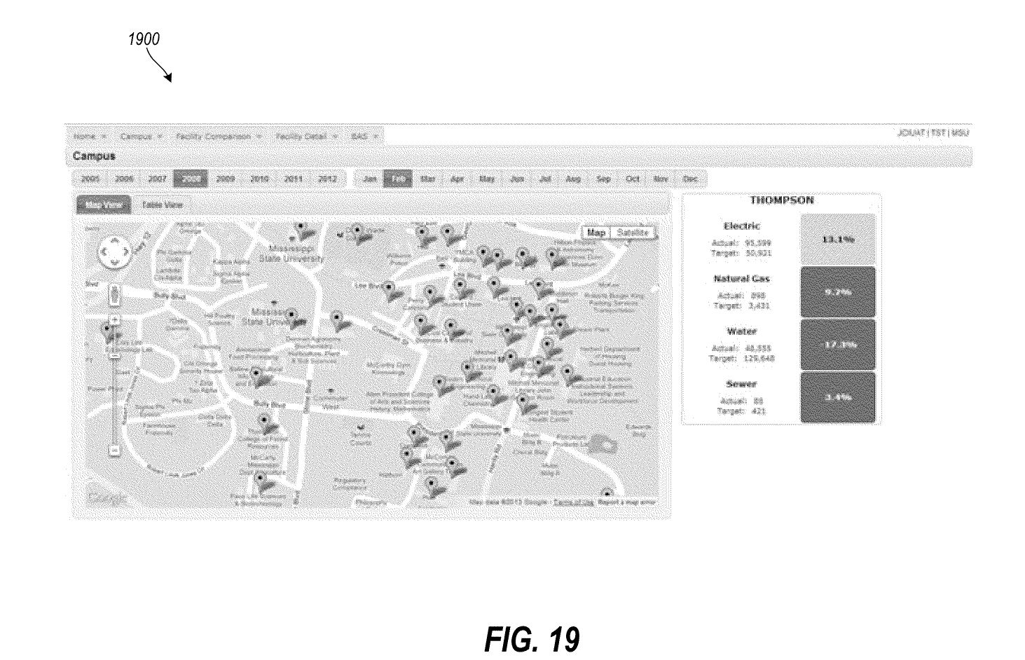

The building location is used to map the building location on a geographical map of the campus shown in the both System Management and Clients dashboard (see Campus Map View in FIG. 19, diagram 1900).

The dot on the map displays a color indicating the overall health of the building. A dark green dot indicates that the building is in excellent health, a light green dot indicates that the building is in good health, a yellow dot indicates fair health, an orange dot indicates serious condition, and red indicates a critical health condition. Placing a pointer on a map dot, results in a small table of information being displayed to the right of the map displayed. The small table as shown (Thompson) in the Campus Map graphic below provides a break down by utility of the buildings consumption against the target consumption. The target consumption can be set by the client or using a System algorithm. The System algorithm calculates the utility consumption for an optimally operating building and establishes a benchmark or target the building should not exceed based on weather, hours of operation, population profiles, HVAC operation, etc. (see parameters used to calculate baseline performance). The benchmark is different from the Baseline calculation provided which is based on conditions prior to modifications to correct OIs and optimize building performance. Benchmarks or Targets shown in the Campus Map dashboard graphic below is updated as OIs are corrected, energy efficiency measures and system optimizations are implemented. The Benchmark or Target utilizes the same calculation process as outlined but uses difference in utility consumption reductions resulting from the modifications to the building, its operation, and estimates of reductions for uncorrected OIs in calculating the Benchmark/Target for each building. The Benchmark/Target model is used to predict the utility consumption based on the same input parameters as the Baseline and Benchmark/Target. The color coding of the utility boxes contained in the small table shown in the Campus Map graphic provides quick identification of utility consumption that is within defined as usage tolerance levels (green), outside of allowable tolerances (yellow), or significantly outside of allowable tolerances (red). The establishment of optimum performance parameters for each utility (energy and water) in combination with color identification allows quick recognition by the owner and their operational team of operational problems that increase the total cost of ownership as they occur. Clicking on the utility that is exceeding allowable operational tolerances takes the user to the OI associated with the increased consumption.

Campus Table

Utility meters, owner installed, associated with the building provide the values displayed as actual. The difference between the Actual and Benchmark/Target is used to determine the color of the utility box. The level of tolerance is determined based on historic accuracy of the Benchmark/Target model. Values significantly outside of normal deviation from the predicted utility consumption are considered outside of allowable tolerances. The percentage by which the allowable tolerances are exceed to be considered significant are determined by the client. Each meter is identified and listed in the utility column of the “Campus Table,” which is the reference for the utility data contained in one of the following: BAS point name, excel file, SQL database, or a paper copy of a utility bill. From the Campus view the table view can be selected.

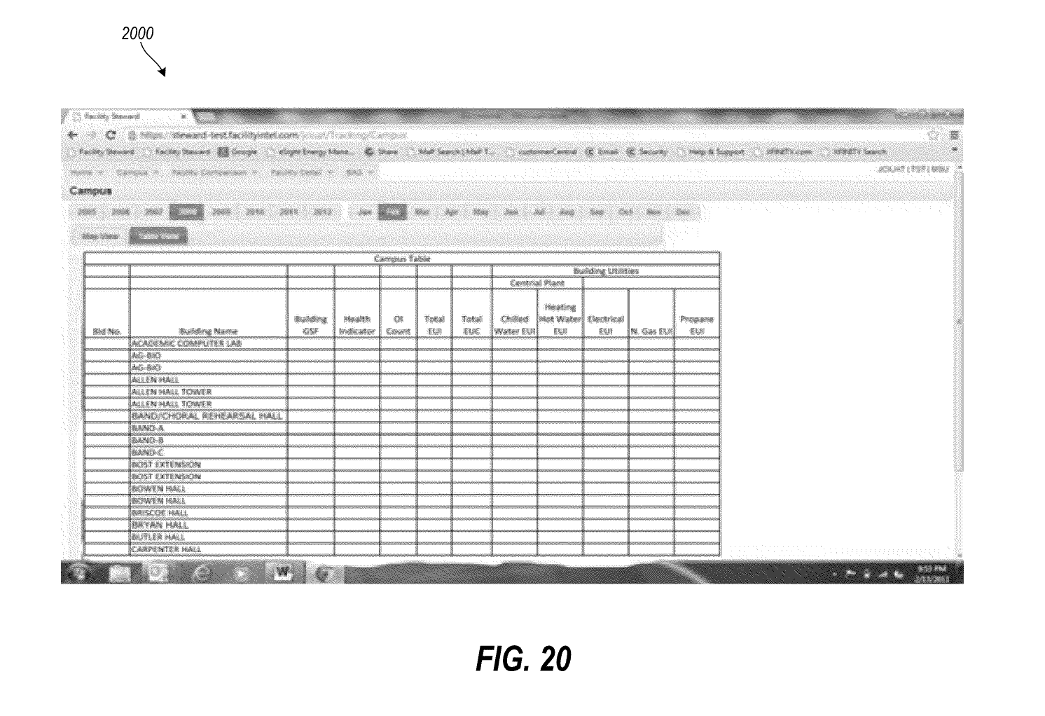

The values in the columns in the Campus Table illustrated in FIG. 20, diagram 2000, are calculated as follows:
Calculate the energy index and the cost index for each fuel, or demand type, and their combined total.
   EUI_{T}=Total annual energy/GSF_{(kBTU/sf-ft·yr) or (kWh/ft2·yr) selectable}
   EUI_{E}=Total annual electrical energy/GSF_{(kBTU/sq-ft·yr) or (kWh/f2·yr) selectable}
   EUI_{NG}=Total natural gas/GSF_{(kBTU/sq2-ft·yr)} (natural gas factors assume the utility bill energy use values include elevation corrections, needed at altitudes above 2,500 ft sea level)
   EUI_{FO}=Total fuel oil/GSF_{(kBTU/sq2-ft·yr)}
   EUI_{W}=Total water/GSF
   ECI_{T}=Total annual energy cost/GSF_{($/sq-sf·yr)}
   ECI_{E}=Total annual electrical cost/GSF_{($/sq-sf·yr)}
   ECI_{NG}=Total natural gas cost/GSF_{($/sq-sf·yr)}
   ECI_{FO}=Total fuel oil cost/GSF_{($/sq-sf·yr)}
   ECI_{FO-HVAC}=Total fuel oil cost-HVAC/GSF_{($/sq-sf·yr)}
   ECI_{FO-PWR}=Total fuel oil cost-power generation/GSF_{($/sq-sf·yr)}
   ECI_{W}=Total water cost/GSF
      The data can also be calculated on monthly utility information. Monthly data is based 0n a 30.416 day cycle and divide by the building square foot area.

Viewing and Printing Reports and Associated Graphic Displays as Defined in the Analysis Levels.

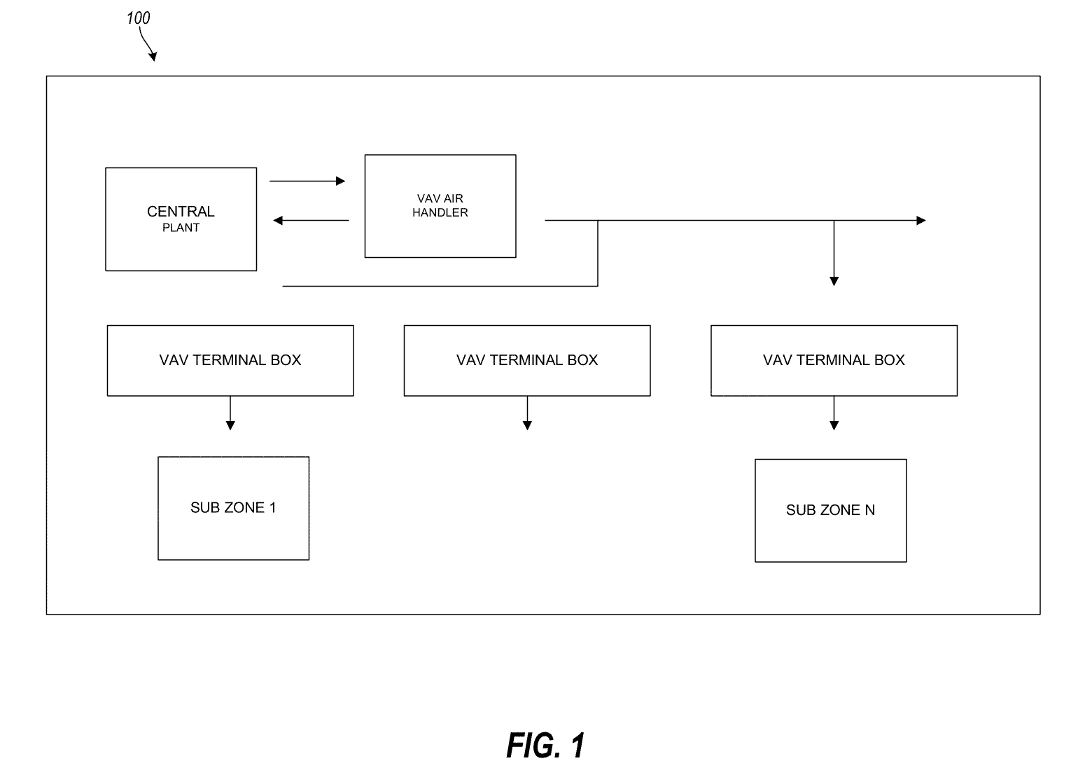

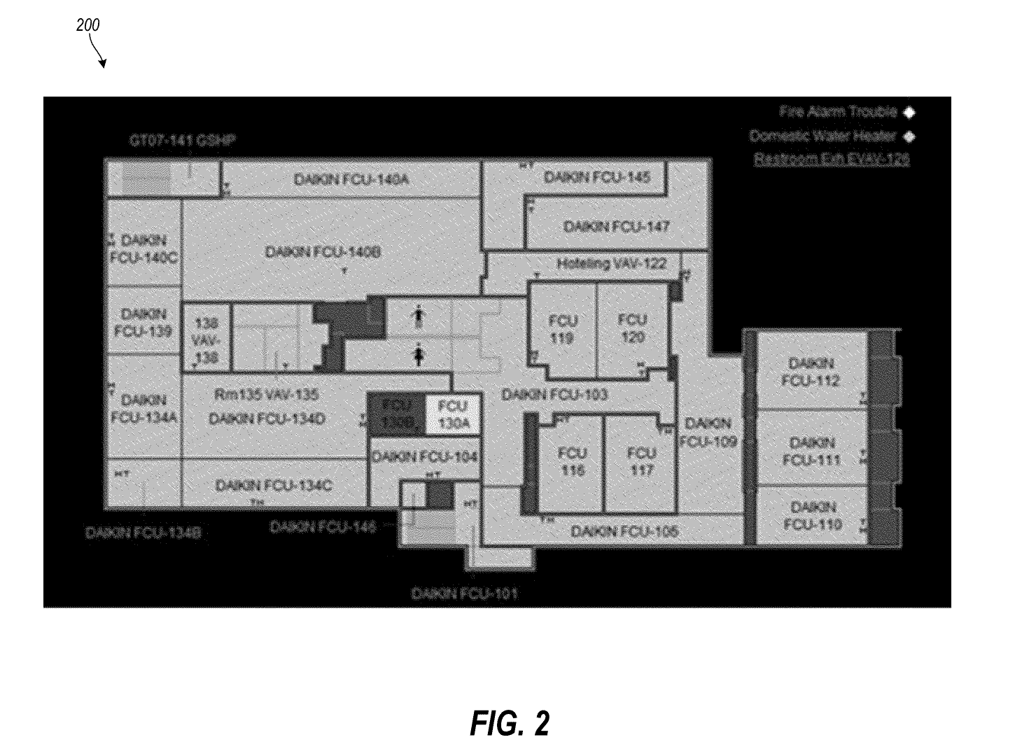

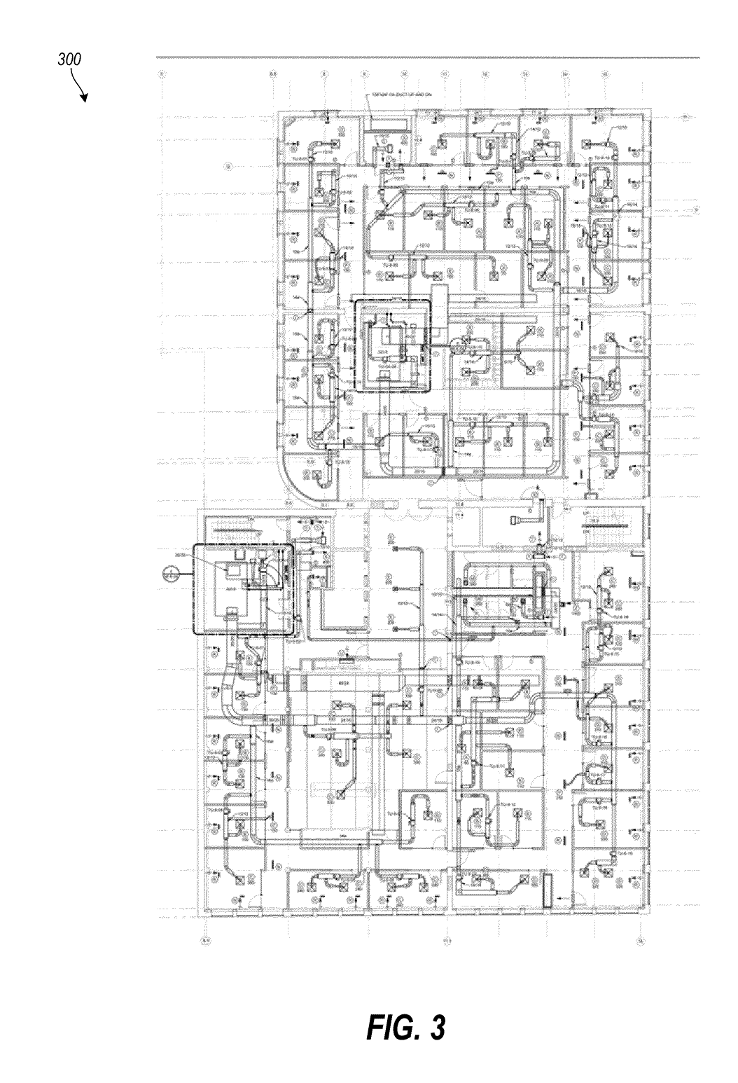

Areas within the building are referred to as subzones (multiple spaces with in zones) and zones. Zones refer to a single air handling unit. Subzones have separate controls within the zone provided by terminal boxes and their points. FIG. 1 diagram 100 provides a simplified graphical representation the whole HVAC system. Table 2 and Table 3 show how this simplified representation is communicated in the application. FIG. 2, diagram 200, illustrates multiple zones served by individual air handling units per zone. Note the FCU name is associated with the zone. FIG. 3 is a typical floor plan for a variable air volume air handler. Note there are two zones as there are two air handling units. FIG. 4 shows the two main air handling unit (AHU) zones as identified by the different zone colors. The subzones are illustrated as the polygons of the same color and the terminal unit (TU) serving the subzone is indicated within the polygon.

FIG. 1 shows the Zone which can be one room or multiple rooms within a floor or multiple floors of the building. The Zone or Subzone can contain a room or several rooms. The relationship between zones and subzones within a building is defined in the “Building System Table, Area Served.” In lieu of a Polygon, a “Building Zone Table” that lists the rooms within each zone or subzone could provide the required information for reporting where no floor plan is present. This information will be used in combination with population information from the human resource department, registers office or a sensor located with the room or rooms.

Points within the subzone include subzone (Zone) temperature, Discharge Air Temperature (DAT), damper position (Damper Pos.), Actual CFM, and Heating Control Valve (HCV) position or Electric Heat enabled all of which are points connected to the terminal unit component. The Terminal unit display, as illustrated in FIG. 5, also contains component data from the design and construction documents which include Design Maximum Airflow (Design Max), Design Minimum Airflow (Design Min), TAB (Test, Adjust, and Balance measurements made at the end of construction) Minimum and Maximum readings. The design and construction data are contained in the Subsystem Table (see Example Tables file).

The subsystem table connects the components, listed in the Building System Table, with their points through the unique Component and Point Tags. The Components and associated points are documented in the design documents, if available, and can be used to build the Building System Table and define the Subsystem Order. The BAS point translation is supported by the reference tables: Point Table, Point Unit Table, and Subsystem Order Table. Table 4 is an example of the Point Table. The Building System Table provides two purposes, the first is to define the relationship of the components, and the second is to reference the areas served by the buildings components. As shown in Table 4, the yellow highlighted columns are programmatically populated, while the green highlighted areas are inputted by System Management. The Building Systems Information Table, currently under development, provides design data from the construction documents and measured data collected during construction and operates like and excel table where the pinkish highlighted cells can be used to calculate variables that can be used in analysis of systems. The gray and green highlighted cells are populated through the UI and stores design and commissioning parameters inputted using the UI editor, which can also be displayed in graphics like FIG. 5.

FIG. 5, diagram 500, illustrates AHU Zone information including Fan Status, Fan Static Pressure (Fan SP), Static Pressure Set Point (SP Set Point), Return Air Relative Humidity (R.A. Rel. Humidity), Return Air Temperature (R.A. Temp.), Chilled Water Valve (CCV), Mixed Air Temperature (Mixed Air Temp), and Discharge Air Temperature (DAT) all of which are points of the component AHU. FIG. 5 also provides AHU CFM which is a calculation that sums the actual airflow CFMs of all of the terminal units in the zone. Other points of the AHU or TUs can include space humidity, carbon dioxide, particulate, and volatile organic compound readings. The application provides importing or drawing the polygons that constitute the zone and subzones and represents the floor plan of the building and mapping fields to input text and display a specific component point parameter for display in the dashboard.

Utilizing FIG. 3, diagram 300, System Management defines the zone and sub zones based on the HVAC design and graphically indicated these zones and subzones on the floor plan comprised of multiple polygons with color fill for easy recognition by the viewer as illustrated in FIG. 4, diagram 400. FIG. 4 also illustrates mapping of components and terminal units (TU) to the polygons. Component points such as room temperature selected by System Management will be displayed and colors associated with displayed temperatures, which will be presented as shown in FIG. 6. FIG. 4 is also the format that will facilitate analysis and communication of some of the operational issues of the building. FIG. 5 illustrates how a subsystem and its components will be illustrated for both analysis and communication of operational issue to the client and function similar to the excel spread example previously provided in that the data is stepped through very quickly relative to time by System Management. FIG. 5 shows the HVAC zone and subzone, the components associated with the zone as represented in the subset component tables, see HVAC characteristics, and the selected points to be displayed with the component for both analysis and communication of operational issues associated with the subsystem.

The subsystem illustrated in FIG. 5 is Air Handling Unit (AHU) 4 and its associated terminal boxes (subcomponents of the AHU). Each component is defined by its Component and Point Tags. As shown in FIG. 5 System Management selected points associated with each component are visible. The UI provides a dashboard development window for importing JPEGs and simple CAD drawing elements. Within the UI dashboard development window text boxes and data fields can be placed on and around the graphics similar to FIGS. 2, 4, 5, 6, 8, 9. Each field would be associated with a Component and Point Tag. The UI dashboard development window, based on selected display option, will step through the selected time period at a selected rate per record. A slider bar will also be available that allows the user to move from beginning to end of the selected date range displaying the variables as the slider bar changes position. The default rate if slider will be 2 sec per record to 1 minute per record (adjustable).

The application's Importing of Computer Aided Drawings (CAD) window supports three dimensional object-based editing software files. The CAD drawing element can have up to four layers to allow computational geometry to be used as analytical geometric algorithms are developed in later phases of the project. The initial use of CAD files will be importing polygon files that represent HVAC zones and subzones as previously described. The Importing CAD window provides tools to connect zones to AHUs and subzones to Terminal Units (TU) contained in the “Building Systems Table” (see Example Table File) and “Area Served.”

Buildings with multiple floors will be associated by floor level. Multiple floor plans shall be displayed in a tiled fashion on the user's screen, Number of floors per screen selectable up to maximum of 12 floors per screen. Buildings exceeding the selectable number of floors per screen will move down webpage to see consecutive floors.

Not all zones have subzones as illustrated in FIG. 2. The subzone is separately controlled by one or more terminal boxes as illustrated in FIG. 5. Multiple terminal boxes can include supply, return, and exhaust air units within one subzone requiring illustration of each TU within a subzone. Each supply, return, and exhaust terminal box is part of a subsystem with their relation defined in “Building System Table.” Level 2 analysis requires subsystems and their subcomponents to be represented by their relationship. FIG. 5 illustrate the relationship for a variable air volume AHU and its subcomponents, terminal boxes, and how the components and points are mapped to illustrate the zone and subzone connectivity and the associated points assigned to provide a graphic representation of information.

FIG. 6, diagram 600, uses the same basic configuration of zones and subzones as illustrated in FIG. 4, except that only the space temperature is displayed and a color represents if the zone is heating, cooling, or neither heating or cooling. This is also a configuration of a level two analysis. Using time interval data, The System methodically steps through the time records of outdoor temperature, and interior temperature of each subzone, and provides color infill to illustrate if the subzone is in heating (red), cooling (blue), or neither (white). Shading of spaces (doted pattern) is used to illustrate different equipment configurations.

Metering

There are two types of metering systems. The first is Utility Company Meters; the second is Building Owner Meters. Both types of meters measure the same type of utility supplied to the building. The Utility Company Meters are recorded by the utility provider and reported to an owner through a monthly paper based billing system. Utility companies are also making this information available to owners over the internet by providing a website that the owner can go to view the data and often download an excel file with the data. Many Owners transfer paper billing information manually to an excel spreadsheet. The System application provides a utility data input window, where either utility data can be entered manually or an excel spreadsheet with the data can be imported. Many buildings will have Building Owner Meters that will send a signal to the BAS or other data collection systems for storage and for displaying information. Building owner metering can have multiple meters, each measuring a utility such as electrical, natural gas, water, etc. In addition, building owners often have submeters that can also be installed. These submeters are typically used to measure specific areas of a building occupied by a tenant, or they could be by load type i.e., plug, lighting, HVAC, etc. In addition, most buildings that receive their chilled and hot water from a central plant, which is located in a different building, have meters that measure the chilled and hot water flow for the building. Building Owner Utility Meters are classified as a subsystem “Metering” using the Point Table and the building they are assigned to is documented in the “Building System Table” similar to the HVAC components. The purpose of metering is as follows:

Measurement of utility usage is a key factor in establishing the building's performance. It is also a method of verification of utility reported consumption. The application will provide a comparison between utility owned meter data and building owner utility data and report the deviation between the two measurements. These measurements include the quantity of utility consumed, the time of day of utility consumption, and per unit cost of the utility. Common electrical rate schedules combine time of day with cost of consumption.

Building Owner Meter and submeter data can be utilized to identify OIs. System Management will use OI analysis levels described above for this purpose.

Benchmarking

Benchmarking is an essential element for measuring improvement in performance. To establish a benchmark conditions that effect performance must be accounted for. See other sections for parameters used and for procedures.

For parameters not available through data mining, The System provides a table that can be completed manually, or data can be imported through a CSV file for data transfer of utility usage for single or multiple buildings. The data is presented in raw as well as normalized formats to include but be limited to FT2/M2 (selectable) of the building providing Energy Intensity/Area and Cost/Area of the building.

Weather data is downloaded by The System and is used in the analysis algorithms to calculate its impact on the HVAC systems energy consumption as outlined. The System uses 15 minute weather data to calculate hourly averages, and performs 8,760 hourly calculations per year utilizing outdoor ambient sensible temperature, wet bulb and dew point temperature, solar radiation, sky clarity, wind speed, indoor sensible air temperatures and relative humidity in analysis algorithms to evaluate energy consumption associated with weather. Energy usage of the building is modeled to create an accurate prediction of energy consumption, related to actual weather conditions.

The energy performance of the building is factored into the building's health indicator, along with occupancy satisfaction, operational staff efficiency, utility and labor costs, frequency of identical or similar system failures, the number of operational issues, and the age of the issues.

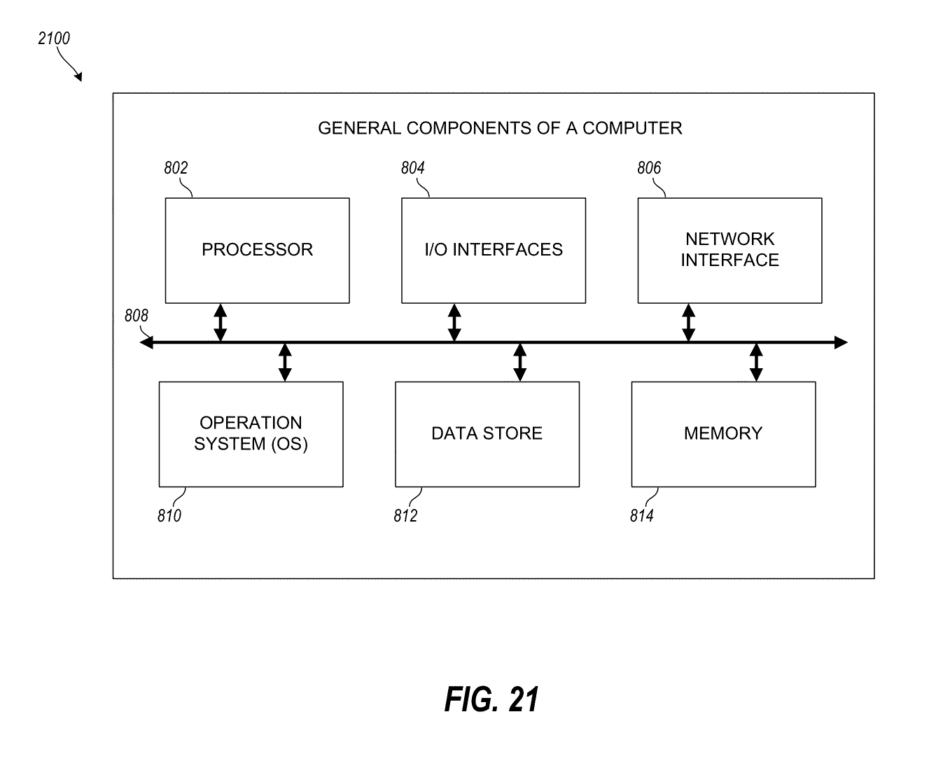

Referring now to FIG. 21, a block diagram 800 illustrating the general components of a computer 2100 is shown. Any one or more of the computers, servers, database, and the like, disclosed above, may be implemented with such hardware and software components. The computer 800 can be a digital computer that, in terms of hardware architecture, generally includes a processor 802, input/output (I/O) interfaces 804, network interfaces 806, an operating system (O/S) 410, a data store 812, and a memory 814. The components (802, 804, 806, 810, 812, and 814) are communicatively coupled via a local interface 808. The local interface 808 can be, for example but not limited to, one or more buses or other wired or wireless connections, as is known in the art. The local interface 808 can have additional elements, which are omitted for simplicity, such as controllers, buffers (caches), drivers, among many others, to enable communications. Further, the local interface 808 can include address, control, and/or data connections to enable appropriate communications among the aforementioned components. The general operation of a computer comprising these elements is well known in the art.

The processor 802 is a hardware device for executing software instructions. The processor 802 can be any custom made or commercially available processor, a central processing unit (CPU), an auxiliary processor among several processors associated with the computer 800, a semiconductor-based microprocessor (in the form of a microchip or chip set), or generally any device for executing software instructions. When the computer 800 is in operation, the processor 802 is configured to execute software stored within the memory 814, to communicate data to and from the memory 814, and to generally control operations of the computer 800 pursuant to the software instructions.

The I/O interfaces 804 can be used to receive user input from and/or for providing system output to one or more devices or components. User input can be provided via, for example, a keyboard and/or a mouse. System output can be provided via a display device and a printer (not shown). I/O interfaces 804 can include, for example but not limited to, a serial port, a parallel port, a small computer system interface (SCSI), an infrared (IR) interface, a radio frequency (RF) interface, and/or a universal serial bus (USB) interface.

The network interfaces 806 can be used to enable the computer 800 to communicate on a network. For example, the computer 800 can utilize the network interfaces 808 to communicate via the internet to other computers or servers for software updates, technical support, etc. The network interfaces 808 can include, for example, an Ethernet card (e.g., 10BaseT, Fast Ethernet, Gigabit Ethernet) or a wireless local area network (WLAN) card (e.g., 802.11a/b/g). The network interfaces 808 can include address, control, and/or data connections to enable appropriate communications on the network.

A data store 812 can be used to store data, such as information regarding positions entered in a requisition. The data store 812 can include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 812 can incorporate electronic, magnetic, optical, and/or other types of storage media. In one example, the data store 812 can be located internal to the computer 800 such as, for example, an internal hard drive connected to the local interface 808 in the computer 800. Additionally in another embodiment, the data store can be located external to the computer 800 such as, for example, an external hard drive connected to the I/O interfaces 804 (e.g., SCSI or USB connection). Finally in a third embodiment, the data store may be connected to the computer 800 through a network, such as, for example, a network attached file server.

The memory 814 can include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 814 may incorporate electronic, magnetic, optical, and/or other types of storage media. Note that the memory 814 can have a distributed architecture, where various components are situated remotely from one another, but can be accessed by the processor 802.

The software in memory 814 can include one or more software programs, each of which includes an ordered listing of executable instructions for implementing logical functions. The operating system 810 essentially controls the execution of other computer programs, such as the interactive toolkit for sourcing valuation, and provides scheduling, input-output control, file and data management, memory management, and communication control and related services. The operating system 810 can be any of Windows NT, Windows 2000, Windows XP, Windows Vista, Windows 7, Windows 8 (all available from Microsoft, Corp. of Redmond, Wash.), Solaris (available from Sun Microsystems, Inc. of Palo Alto, Calif.), LINUX (or another UNIX variant) (available from Red Hat of Raleigh, N.C.), Android, or other like operating system with similar functionality.

In an exemplary embodiment of the technology described herein, one or more computers 2100 are configured to perform one or more elements of depicted in the flowcharts and Figures.

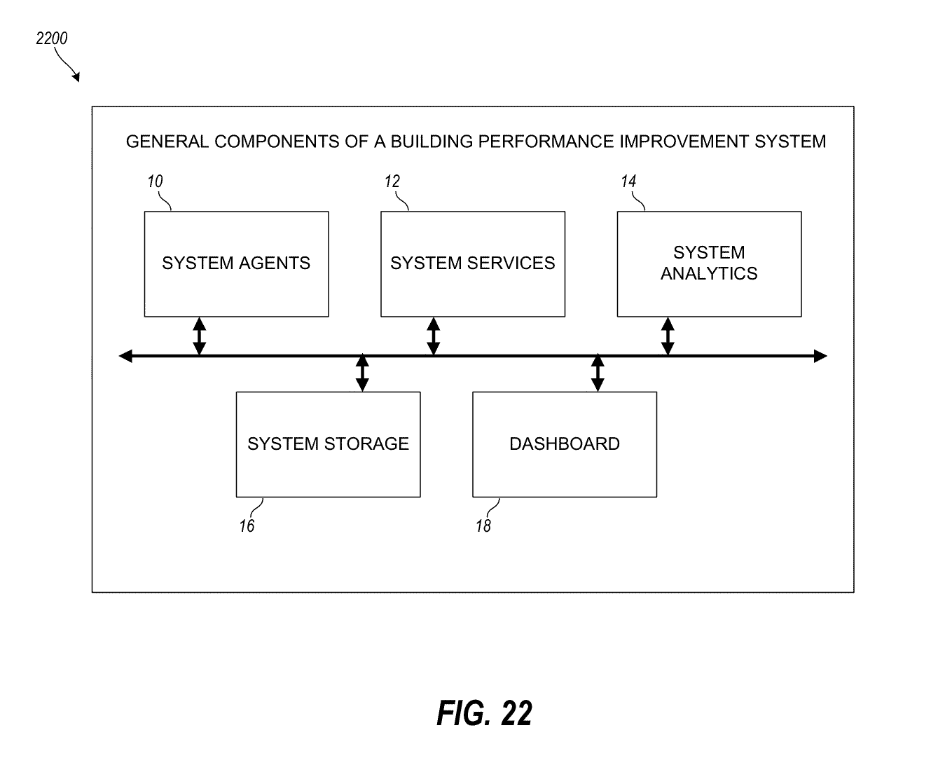

Referring now to FIG. 22, diagram 2200, the general components of a building performance improvement system, previously discussed, are shown. The System in 220 includes System Agents 10, System Services 12, System Analytics 14, System Storage 16, and the Dashboard 18, all coupled to one another for electronic communication.

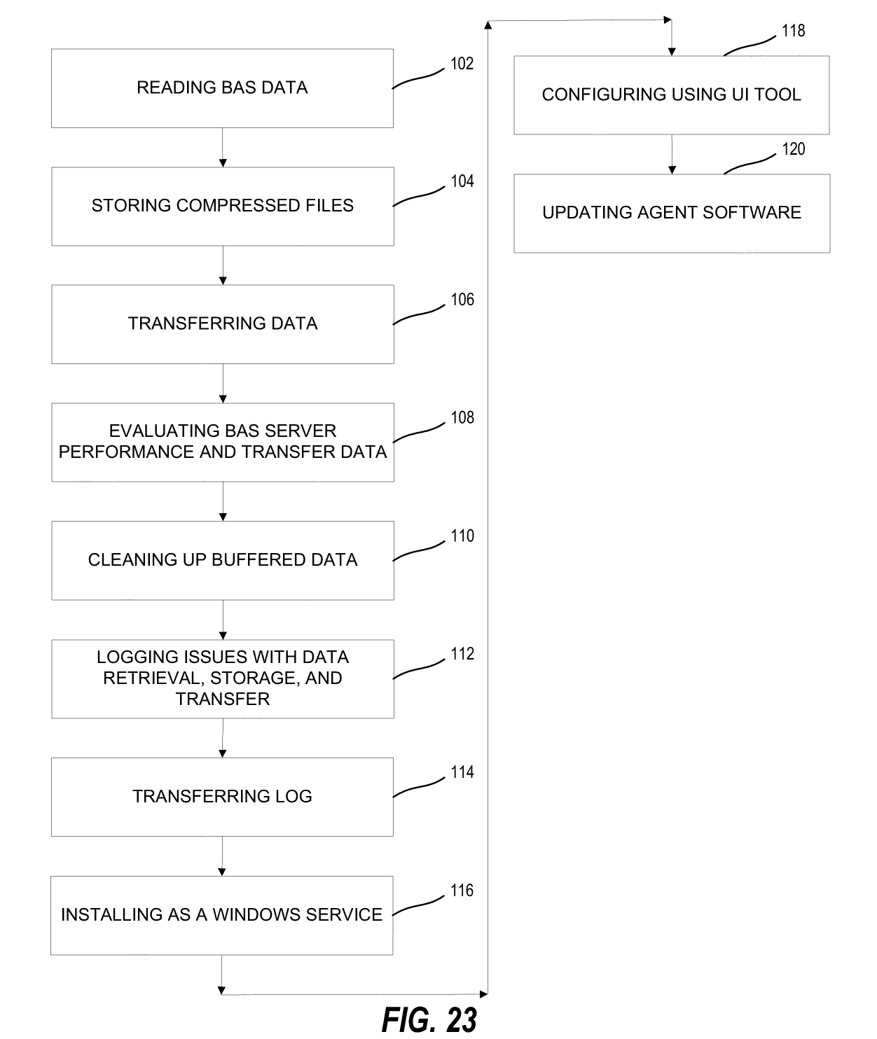

Referring now to FIG. 23, diagram 2200, methods steps that can be performed by the System Agent are depicted. At step 102, the Agent is reading BAS data from the BAS database. At step 104, the Agent is storing files, such as for example, compressed CSV files. At step 106, the Agent is transferring data using HTTPS/SFTP protocols, for example. At step 108, the Agent is evaluating BAS server performance and transferring data based on availability of sever resources so as to not impact the BAS performance. At step 110, the Agent is cleaning up buffered data after successful transfer to the System Service. At step 112, the Agent is logging issues with data retrieval, storage, and transfer. At step 114, the Agent is transferring the log to the System Service. At step 116, the Agent is installing, as a Windows service for example. At step 118, the Agent is configurable using a user interface such as the Google UI tool. At step 120, the Agent is allowing automatic updating of the agent software. As will be apparent to one of ordinary skill in the art after reading this disclosure, the methods steps noted above can vary in some embodiments in terms of order and use or non-use.

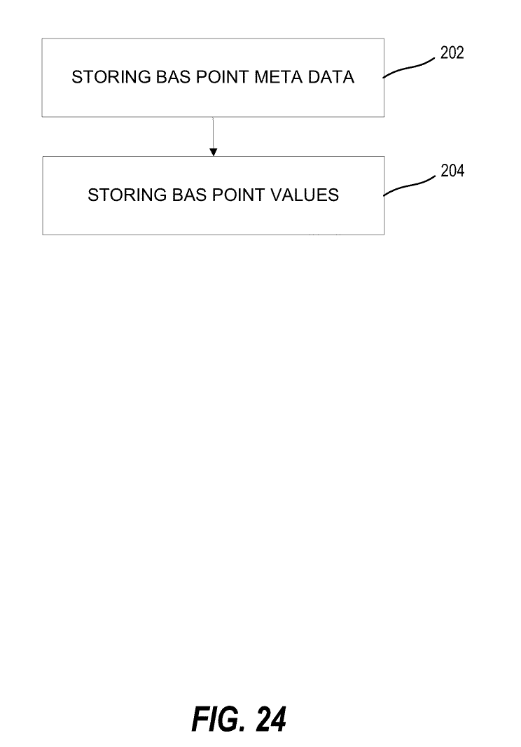

Referring now to FIG. 24, diagram 2400, methods steps that can be performed by the System Storage are depicted. The System Storage provides storage for multiple data types. At step 202, the System Storage is storing BAS point meta data. At step 204, the System Storage is storing BAS point values. As will be apparent to one of ordinary skill in the art after reading this disclosure, the methods steps noted above can vary in some embodiments in terms of order and use or non-use.

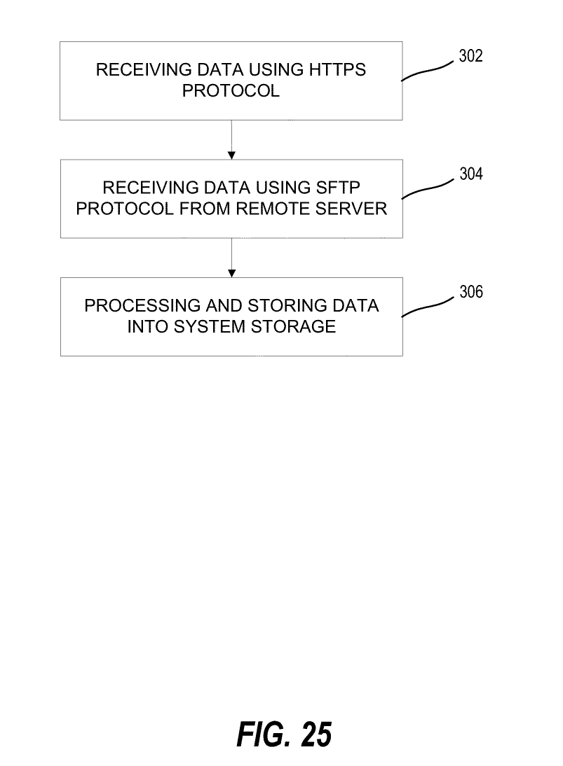

Referring now to FIG. 25, diagram 2500, methods steps that can be performed by the System Service are depicted. At step 302, the System Service is receiving data using the HTTPS protocol. At step 304, the System Service is receiving data using SFTP protocol from remote servers. At step 306, the System Service is processing and storing data into System Storage. As will be apparent to one of ordinary skill in the art after reading this disclosure, the methods steps noted above can vary in some embodiments in terms of order and use or non-use.

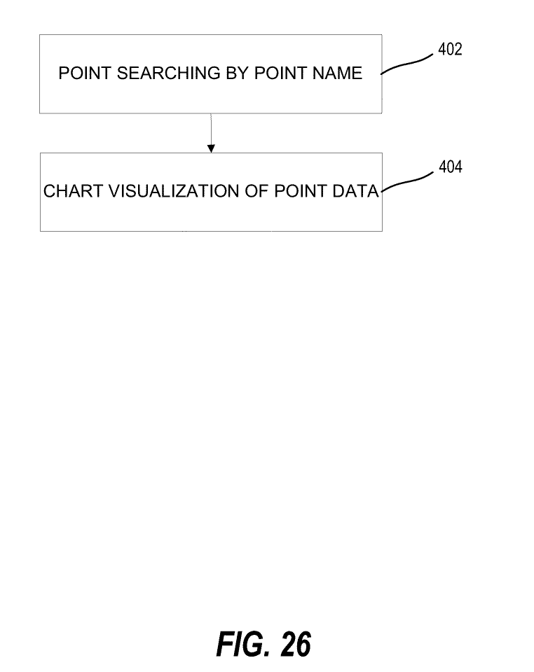

Referring now to FIG. 26, diagram 2600, methods steps that can be performed by the System Dashboard are depicted. At step 402, the System Dashboard is used for point searching by point name. At step 404, the System Dashboard is used for chart visualization of point data. By way of example, the System Dashboard chart visualization of point data includes the following functionality and limitations: 1) Maximum of 16 points per graph; 2) Range between 1 hour and 1 year; 3) Zoom level with aggregation between 10 minutes and 1 day; 4) Tabular data visualization; 5) Tabular data export to CSV file for given period; 6) Agent status monitoring; 7) Agent remote configuration; and 8) Manual data import into System Service using CSV of format defined in Data Sample. As will be apparent to one of ordinary skill in the art after reading this disclosure, the methods steps noted above can vary in some embodiments in terms of order and use or non-use.

Although this technology has been illustrated and described herein with reference to preferred embodiments and specific examples thereof, it will be readily apparent to those of ordinary skill in the art that other embodiments and examples can perform similar functions and/or achieve like results. All such equivalent embodiments and examples are within the spirit and scope of the invention and are intended to be covered by the following claims.

What is claimed is:

1. A method for conducting building commissioning processes and building performance improvement, the method comprising:
providing a plurality of system agents, each agent configured to collect data from a plurality of sources and transmit the data, in an encrypted format, to a service provider;
providing at least one system service, the system service residing on one or more servers at a service provider, the system service configured to receive the data from the plurality of system agents and to classify the data by client, building, and type of information received, and then to be stored in a system storage database;
providing a plurality of system service analytics, each configured to review data and attributes for building commissioning and building performance improvement;
providing a system storage database, the system storage database configured to store data collected by the plurality of system agents and processed by the at least one system service;
collecting data from the plurality of sources, by the plurality of system agents;
transmitting, by the plurality of system agents, the collected data to the service provider;
receiving, by the at least one system service, the data transmitted from the plurality of system agents;
classifying, by the at least one system service, the data by client, building, and type of information received;
storing the received data in the system storage database; and
identifying, by the system service and a plurality of system service analytics, operational issues affecting building performance.

2. The method of claim 1, further comprising:
prioritizing, by the system service and a plurality of system service analytics, the operational issues affecting building performance to achieve building performance improvement, lessened environmental impact, and increased efficiency of building operations and reduced expenses and total cost of ownership.

3. The method of claim 1, further comprising:
providing access to a building automation system (BAS);
wherein each of the plurality of system agents is configured to the read building automation system (BAS) data and to store the data read.

4. The method of claim 1, further comprising:
providing a dashboard interface to provide a user with visual illustrations of the health and status of one or more client buildings using visual signals and indicia to indicate the wellness of the building and further to identify any problems of building health with the one or more client buildings.

5. The method of claim 1, wherein each of the plurality of system agents is configured further to evaluate a building automation system (BAS) performance and to transfer data based on an availability of server resources so as to not impact performance of the BAS.

6. The method of claim 1, wherein each of the plurality of system agents is configured further to clean up buffered data after successful transfer to the at least one system service and to log any issues with data retrieval, storage, and transfer.

7. The method of claim 1, further comprising:
providing a user interface tool;
configuring the plurality of system agents with the user interface tool.

8. The method of claim 1, further comprising:
updating automatically, with software updates, the plurality of system agents;
wherein each of the plurality of system agents is configured further to be automatically updated.

9. The method of claim 1, further comprising:
storing, by the system storage database, building automation system (BAS) point meta data; and
storing, by the system storage database, BAS point values.

10. The method of claim 1, further comprising:
receiving, by the at least one system service, data using the HTTPS protocol;
receiving, by the at least one system service, data using the SFTP protocol from a remote server; and
processing and storing data, by the at least one system service, into the system storage.

11. A system for conducting building commissioning processes and building performance improvement, the system comprising:
a plurality of system agents, each agent configured to collect data from a plurality of sources and transmit the data, in an encrypted format, to a service provider;
at least one system service, the system service residing on one or more servers at a service provider, the system service configured to receive the data from the plurality of system agents and to classify the data by client, building, and type of information received, and then to be stored in a system storage database;
a plurality of system service analytics, each configured to review data and attributes for building commissioning and building performance improvement; and
a system storage database, the system storage database configured to store data collected by the plurality of system agents and processed by the at least one system service;
wherein the system collectively is configured to identify, by the system service and a plurality of system service analytics, operational issues affecting building performance.

12. The system of claim 11, wherein the system service and a plurality of system service analytics is further configured to prioritize the operational issues affecting building performance to achieve building performance improvement, lessened environmental impact, and increased efficiency of building operations and reduced expenses and total cost of ownership.

13. The system of claim 11, further comprising:
access to a building automation system (BAS);
wherein each of the plurality of system agents is configured to the read building automation system (BAS) data and to store the data read.

14. The system of claim 11, further comprising:
a dashboard interface to provide a user with visual illustrations of the health and status of one or more client buildings using visual signals and indicia to indicate the wellness of the building and further to identify any problems of building health with the one or more client buildings

15. The system of claim 11, further comprising:
a user interface tool;
wherein the plurality of system agents are configurable with the user interface tool.

16. A computer readable storage medium encoded with programming for implementing a system for conducting building commissioning processes and building performance improvement, the computer readable storage medium encoded with programming configured to:
provide a plurality of system agents, each agent configured to collect data from a plurality of sources and transmit the data, in an encrypted format, to a service provider;
provide at least one system service, the system service residing on one or more servers at a service provider, the system service configured to receive the data from the plurality of system agents and to classify the data by client, building, and type of information received, and then to be stored in a system storage database;
provide a plurality of system service analytics, each configured to review data and attributes for building commissioning and building performance improvement;
provide a system storage database, the system storage database configured to store data collected by the plurality of system agents and processed by the at least one system service;
collect data from the plurality of sources, by the plurality of system agents;
transmit, by the plurality of system agents, the collected data to the service provider;
receive, by the at least one system service, the data transmitted from the plurality of system agents;
classify, by the at least one system service, the data by client, building, and type of information received;
store the received data in the system storage database; and
identify, by the system service and a plurality of system service analytics, operational issues affecting building performance.

17. The computer readable storage medium of claim 15, wherein the programming is further configured to:
prioritize, by the system service and a plurality of system service analytics, the operational issues affecting building performance to achieve building performance improvement, lessened environmental impact, and increased efficiency of building operations and reduced expenses and total cost of ownership.

18. The computer readable storage medium of claim 15, wherein the programming is further configured to:
provide access to a building automation system (BAS);
wherein each of the plurality of system agents is configured to the read building automation system (BAS) data and to store the data read.

19. The computer readable storage medium of claim 15, wherein the programming is further configured to:
provide a dashboard interface to provide a user with visual illustrations of the health and status of one or more client buildings using visual signals and indicia to indicate the wellness of the building and further to identify any problems of building health with the one or more client buildings.

20. The computer readable storage medium of claim 15, wherein the programming is further configured to:
update automatically, with software updates, the plurality of system agents;
wherein each of the plurality of system agents is configured further to be automatically updated;
store, by the system storage database, building automation system (BAS) point meta data;
store, by the system storage database, BAS point values;
receive, by the at least one system service, data using the HTTPS protocol;
receive, by the at least one system service, data using the SFTP protocol from a remote server; and
process and store data, by the at least one system service, into the system storage.
